(19) United States
(12) Patent Application Publication
(10) Pub. No.: US 2012/0120040 A1
(43) Pub. Date: May 17, 2012

(54) Drive Device For Display Circuit, Display Device, And Electronic Apparatus

(75) Inventor: Yasuyuki Ogawa, Osaka (JP)

(73) Assignee: SHARP KABUSHIKI KAISHA, Osaka-shi, Osaka (JP)

(21) Appl. No.: 13/387,223

(22) PCT Filed: Apr. 16, 2010
(86) PCT No.: PCT/JP2010/056860

§ 371 Date: Jan. 26, 2012

(30) Foreign Application Priority Data
Jul. 30, 2009 (JP) 2009-177554

(51) Int. Cl. G09G 3/36; G09G 5/00

(52) U.S. Cl. 345/208; 345/94

(57) ABSTRACT

A drive device includes a plurality of latch circuits provided correspondingly to a plurality of signal lines respectively. A plurality of latch circuits each obtain a plurality of bit data at a time that constitute pixel data and output the plurality of bit data sequentially. A plurality of latch circuits each include a plurality of latch unit circuits arranged in series along the direction in which a plurality of signal lines extend and each configured to obtain one-bit data and transfer the one-bit data.

### TECHNICAL FIELD

The present invention relates to a drive device for a display circuit, a display device, and an electronic apparatus. In particular, the present invention relates to a drive device for a display circuit including pixel display circuits and signal lines for transmitting analog signals to the pixel display circuits, a display device including the drive device, and an electronic apparatus including the display device.

### BACKGROUND ART

In recent years, liquid crystal display devices have become used as display devices for a number of electronic apparatuses. Among multiple types of liquid crystal display devices, an active-matrix liquid crystal display device that includes a plurality of pixels arranged in rows and columns and a plurality of thin-film transistors (hereinafter referred to as “TFT”) provided for respective pixels is coming into the mainstream of the liquid crystal display device. A TFT is formed of an amorphous silicon (a-Si) or a polycrystalline silicon (p-Si). By using polycrystalline silicon to form TFTs, not only switching elements for pixels but also a drive circuit can be formed on a surface of a single insulating substrate.

The drive circuit is disposed in a region called “frame region” on the insulating substrate, namely a region around a display unit. With the aim of narrowing the frame region, techniques of downsizing the drive circuit have been proposed.

For example, Japanese Patent Laying-Open No. 2007-193237 (PTL 1) discloses a display device including two horizontal drive circuits arranged respectively on the upper side and the lower side of an effective pixel portion. The two horizontal drive circuits each include a first latch system sampling and latching two of R (red) data, G (green) data, and B (blue) data, a second latch system sampling and latching the remaining one of these three pieces of data, a D/A (digital/analog) converter converting the three pieces of data latched by the first and second latch systems into analog data, and a line selector selecting, in a time-division manner, one of the three pieces of analog data that are output from the D/A converter and outputting the selected one to a corresponding data line. This configuration enables reduction of the number of D/A converters and analog buffers, as compared with existing systems, that are required for the same pixel pitch width. In this way, the frame region can be narrowed.

For example, Japanese Patent Laying-Open No. 2006-171034 (PTL 2) discloses, similarly to PTL 1, a display device including two horizontal drive circuits arranged respectively on the upper side and the lower side of an effective pixel portion. According to PTL 2, one of the two horizontal drive circuits serially drives data lines in accordance with two of R data, G data, and B data, and the other of the two horizontal drive circuits serially drives data lines in accordance with the remaining data.

For example, Japanese Patent Laying-Open No. 2000-305535 (PTL 3) discloses a configuration of a drive circuit with the aim of reducing the circuit size. This drive circuit includes a D/A converter reallocating electrical charges between a first capacitor and a second capacitor.

For example, Japanese Patent Laying-Open No. 2001-337657 (PTL 4) discloses a configuration of a liquid crystal display device with the aim of simplifying the configuration of a signal line drive circuit. This liquid crystal display device includes sampling latch circuits, load latch circuits, and D/A conversion circuits, and the number of the circuits is one sixth of the total number of signals. The liquid crystal display device drives signal lines six times for every six signal lines.

For example, Japanese Patent Laying-Open No. 2003-208132 (PTL 5) discloses a configuration of a liquid crystal drive circuit with the aim of reducing the chip area. The liquid crystal drive circuit includes a memory circuit for temporarily storing input image data, a first selection circuit successively selecting image data of multiple channels read from the memory circuit and outputting the image data in a time-division manner, a digital/analog conversion circuit converting the image data that is output in a time-division manner from the first selection circuit into analog image signals, an amplifier circuit amplifying the analog image signals obtained by the digital/analog conversion circuit, and a second selection circuit successively selecting a plurality of output terminals to thereby distribute the analog image signals amplified by the amplification circuit to a plurality of output terminals in a time-division manner.

### CITATION LIST

### Patent Literature

PTL 1: Japanese Patent Laying-Open No. 2007-193237
PTL 2: Japanese Patent Laying-Open No. 2006-171034
PTL 3: Japanese Patent Laying-Open No. 2000-305535
PTL 4: Japanese Patent Laying-Open No. 2001-337657
PTL 5: Japanese Patent Laying-Open No. 2003-208132

### SUMMARY OF INVENTION

### Technical Problem

In order to achieve high-quality display, a liquid crystal display panel is required to have a high resolution. Meanwhile, in order to provide multi-gray-level display, it is necessary to convert multi-bit digital data into analog signals by a drive circuit.

For example, PTL 3 and PTL 4 each disclose a configuration in which a plurality of bits are output in parallel from latch circuits. In order to output a plurality of bits in parallel from latch circuits, data transfer lines of the same number as the number of bits constituting pixel data are required. It is therefore difficult for the configurations of PTL 3 and PTL 4 to further downsize drive circuits.

PTL 1, PTL 2, and PTL 5 do not explicitly describe that a plurality of bits are output in parallel from latch circuits. It, however, can easily be imagined that a similar problem to the above-described one occurs as well to respective configurations disclosed in PTL 1, PTL 2, and PTL 5.

For example, in the configuration disclosed in PTL 1, the first latch system samples and latches two types of data while the second latch system samples and latches one type of data. In the configuration disclosed in PTL 1, a common data transfer line is used to transfer each of the two types of data by the first latch system. The number of data transfer lines, however, can only be reduced to approximately two thirds of the number of data transfer lines necessary for transferring all data (the product of the number of bits and the number of types of data).

An object of the present invention is to provide a technique for downsizing a drive device for a display circuit.

### Solution to Problem

The present invention in an aspect is a drive device for a display circuit. The display circuit includes a plurality of pixel display circuits arranged in a plurality of rows and a plurality of columns, and a plurality of signal lines provided for the columns respectively and extending along a direction of the columns. The drive device includes a plurality of latch circuits provided correspondingly to the plurality of signal lines respectively and each configured to obtain a plurality of bit data at a time that constitute pixel data and output the plurality of bit data sequentially. The plurality of latch circuits each include a plurality of first latch unit circuits arranged in series along the direction of the columns and each configured to obtain one-bit data and transfer the one-bit data. The drive device further includes a conversion unit configured to convert into an analog signal the plurality of bit data that are output from each of the plurality of latch circuits, and an output unit configured to output the analog signal from the conversion unit to a corresponding signal line of the plurality of signal lines.

Preferably, at least one latch unit circuit of the plurality of first latch unit circuits includes: an output node for outputting the one-bit data to a stage subsequent to the at least one latch unit circuit; a first input node for receiving corresponding bit data of the plurality of bit data; and a second input node for receiving the one-bit data from a stage preceding the at least one latch unit circuit.

Preferably, the at least one latch unit circuit is configured so that one of a first mode and a second mode can be selected, the at least one latch unit circuit in the first mode receives the corresponding bit data from the first input node in response to a control signal and outputs the one-bit data from the output node, and the at least one latch unit circuit in the second mode receives the one-bit data from the second input node and outputs the one-bit data from the output node.

Preferably, the at least one latch unit circuit is configured to output the one-bit data in response to single-phase clock in the second mode.

Preferably, the control signal is a single-phase signal.

Preferably, the plurality of latch circuits are arranged along a direction of the rows. The conversion unit includes a plurality of conversion circuits provided correspondingly to the plurality of latch circuits respectively and configured to convert into the analog signal the plurality of bit data that are output from a corresponding latch circuit. The output unit includes a plurality of output buffers provided correspondingly to the plurality of conversion circuits respectively and configured to output the analog signal that is output from a corresponding conversion circuit to a corresponding signal line.

Preferably, the plurality of latch circuits are arranged along a direction of the rows. The conversion unit includes a plurality of conversion circuits each provided for a predetermined number of latch circuits of the plurality of latch circuits and configured to convert into the analog signal the plurality of bit data that are output from each of the predetermined number of latch circuits. The output unit includes a plurality of selectors provided correspondingly to the plurality of conversion circuits respectively and configured to select, in a time-division manner in a predetermined period of time, one of the analog signals that are output from a corresponding conversion circuit and output the selected analog signal to a corresponding signal line.

Preferably, the plurality of latch circuits are arranged along the direction of the rows. The plurality of latch circuits each further include a plurality of second latch unit circuits provided correspondingly to the plurality of first latch unit circuits respectively and arranged in series with corresponding first latch unit circuits along the direction of the columns. The plurality of second latch unit circuits are each configured to sequentially transfer the plurality of bit data that are output from corresponding first latch circuits to a stage subsequent to the second latch unit circuit.

Preferably, the plurality of latch circuits, the conversion unit, and the output unit are divided into a first block and a second block that are arranged along the direction of the columns so that the display circuit is located between the first and second blocks. The plurality of latch circuits each further include a plurality of second latch unit circuits provided respectively in respective preceding stages of the plurality of first latch unit circuits. The plurality of second latch unit circuits are each configured to latch corresponding bit data of the plurality of bit data and transfer the corresponding bit data to the first latch unit circuit arranged in a stage subsequent to the second latch unit circuit.

The present invention in another aspect is a display device. The display device includes a display circuit and a drive circuit for driving the display circuit. The display circuit includes a plurality of pixel display circuits arranged in a plurality of rows and a plurality of columns, and a plurality of signal lines provided for the columns respectively and extending along a direction of the columns. The drive circuit includes a plurality of latch circuits provided correspondingly to the plurality of signal lines respectively and each configured to obtain a plurality of bit data at a time that constitute pixel data and output the plurality of bit data sequentially. The plurality of latch circuits each include a plurality of latch unit circuits arranged in series along the direction of the columns and each configured to obtain one-bit data and transfer the one-bit data. The drive circuit further includes: a conversion unit configured to convert into an analog signal the plurality of bit data that are output from each of the plurality of latch circuits; and an output unit configured to output the analog signal from the conversion unit to a corresponding signal line of the plurality of signal lines.

Preferably, the display circuit and the drive circuit are formed integrally on an insulating substrate.

Preferably, the plurality of pixel display circuits each include a liquid crystal cell.

The present invention in still another aspect is an electronic apparatus. The electronic apparatus includes a display device, and a processor for causing the display device to display an image. The display device includes a display circuit and a drive circuit for driving the display circuit. The display circuit includes a plurality of pixel display circuits arranged in a plurality of rows and a plurality of columns, and a plurality of signal lines provided for the columns respectively and extending along a direction of the columns. The drive circuit includes a plurality of latch circuits provided correspondingly to the plurality of signal lines respectively and each configured to obtain a plurality of bit data at a time that constitute pixel data and output the plurality of bit data sequentially. The plurality of latch circuits each include a plurality of latch unit circuits arranged in series along the direction of the columns and each configured to obtain one-bit data and transfer the one-bit data. The drive circuit further includes: a conversion unit configured to convert into an analog signal the plurality of bit data that are output from each of the plurality of latch circuits; and an output unit configured to output the analog signal from the conversion unit to a corresponding signal line of the plurality of signal lines.

### Advantageious Effects of Invention

The present invention can downsize the drive circuit driving the display circuit.

### BRIEF DESCRIPTION OF DRAWINGS

FIG. 1 is a block diagram showing an example configuration of a display device including a drive circuit according to a first embodiment.

FIG. 2 is a diagram for illustrating in more detail a configuration of a display unit 12 shown in FIG. 1.

FIG. 3 is a schematic configuration diagram of a pixel display circuit 2 shown in FIG. 1

FIG. 4 is a block diagram showing a configuration of a signal line drive circuit 13 shown in FIG. 1.

FIG. 5 is a diagram for illustrating sampling and output of a pixel data signal by a latch circuit 211 shown in FIG. 4.

FIG. 6 is a diagram schematically showing a configuration of latch circuit 211 shown in FIG. 5.

FIG. 7 is a circuit diagram showing an example configuration of a latch unit circuit shown in FIG. 6.

FIG. 8 is a timing chart showing operation waveforms of latch circuit 211 made up of the latch unit circuits shown in FIG. 7.

FIG. 9 is a circuit diagram showing another example configuration of the latch unit circuit shown in FIG. 6.

FIG. 10 is a timing chart showing operation waveforms of latch circuit 211 made up of the latch unit circuits shown in FIG. 9.

FIG. 11 is a diagram conceptually showing a configuration of a cyclic-type D/A converter applicable to embodiments of the present invention.

FIG. 12 is a diagram showing a first example to be considered of the configuration of the latch circuit.

FIG. 13 is a diagram showing a second example to be considered of the configuration of the latch circuit.

FIG. 14 is a diagram showing a third example to be considered of the configuration of the latch circuit.

FIG. 15 is a diagram showing an arrangement of the latch unit circuits in the first embodiment.

FIG. 16 is a block diagram showing a configuration of a signal line drive circuit including level shift circuits.

FIG. 17 is a block diagram showing an example configuration of a display device including a drive circuit according to a second embodiment.

FIG. 18 is a block diagram showing a configuration of a signal line drive circuit 13A shown in FIG. 17.

FIG. 19 is a diagram for illustrating input and output of latch circuits 211, 261.

FIG. 20 is a diagram schematically illustrating a configuration of latch circuits 211, 261 shown in FIG. 19.

FIG. 21 is a circuit diagram showing a configuration of a latch unit circuit L0′.

FIG. 22 is a timing chart showing operation waveforms of latch circuits 211, 261 shown in FIGS. 20 and 21.

FIG. 23 is a block diagram showing an example configuration of a display device including a drive circuit according to a third embodiment.

FIG. 24 is a diagram showing a configuration of a signal line drive circuit 13B1 shown in FIG. 23.

FIG. 25 is a diagram for illustrating input and output of latch circuits 211, 271 shown in FIG. 24.

FIG. 26 is a diagram schematically illustrating a configuration of latch circuits 211, 271 shown in FIG. 25.

FIG. 27 is a timing chart showing operation waveforms of latch circuits 211, 271 made up of the latch unit circuits shown in FIGS. 25 and 26.

FIG. 28 is a diagram showing an example of an electronic apparatus including a display device according to an embodiment of the present invention.

### DESCRIPTION OF EMBODIMENTS

Embodiments of the present invention will hereinafter be described in detail with reference to the drawings. In the drawings, the same or corresponding components are denoted by the same reference characters, and a description thereof will not be repeated.

In connection with the embodiments of the present invention described below, a liquid crystal panel is illustrated as a specific example of the display device.

### First Embodiment

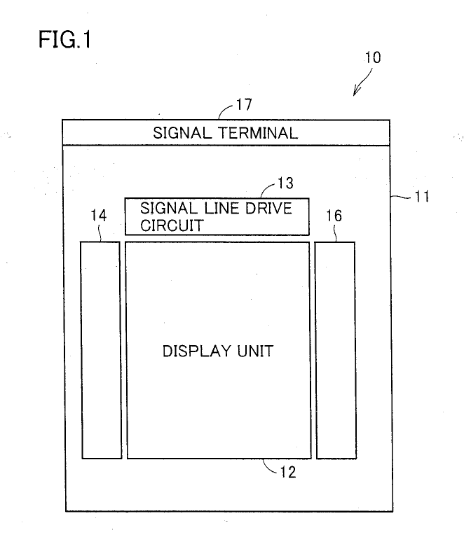

FIG. 1 is a block diagram showing an example configuration of a display device including a drive circuit according to a first embodiment. Referring to FIG. 1, a liquid crystal panel 10 includes a substrate 11, a display unit 12, a signal line drive circuit 13, a scan line drive circuit 14, a peripheral circuit 16, and a signal terminal 17. Substrate 11 is a light-transmitting and electrically-insulating substrate, and formed of a material such as glass or resin.

Display unit 12, signal line drive circuit 13, scan line drive circuit 14, peripheral circuit 16, and signal terminal 17 are mounted on a surface of substrate 11. Signal line drive circuit 13, scan line drive circuit 14, and peripheral circuit 16 are arranged in a peripheral region, namely a frame region of display unit 12. Signal terminal 17 is a terminal for receiving signals from outside liquid crystal panel 10. Peripheral circuit 16 includes a power supply circuit for operating for example signal line drive circuit 13 and scan line drive circuit 14. Signal terminal 17 is connected for example to a FPC (Flexible Printed Circuit) board.

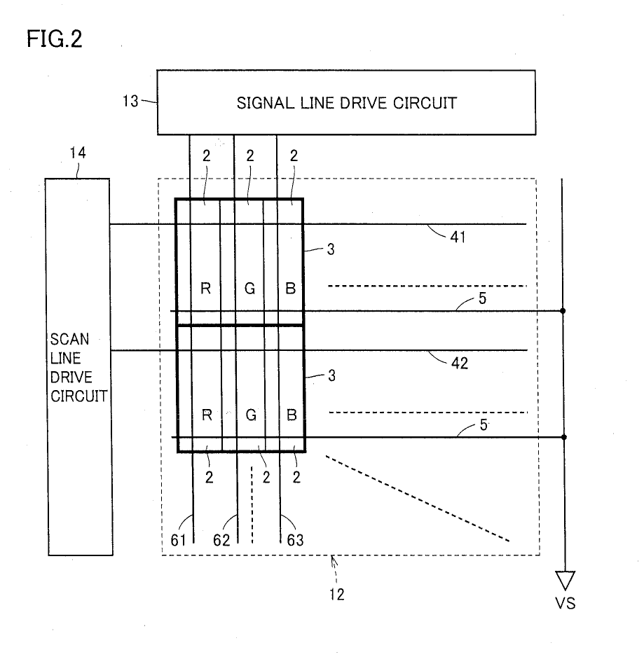

FIG. 2 is a diagram for illustrating in more detail a configuration of display unit 12 shown in FIG. 1. Referring to FIG. 2, display unit 12 includes a plurality of pixel display circuits 2 arranged in a plurality of rows and a plurality of columns, a plurality of scan lines provided correspondingly to rows, respectively, and a plurality of data signal lines provided correspondingly to columns, respectively. FIG. 2 shows, as representative ones, scan lines 41 and 42 provided correspondingly to two rows respectively and data signal lines 61, 62, 63 provided correspondingly to three columns respectively. The direction along which each of scan lines 41, 42 extend corresponds to the row direction, and the direction along which each of data signal lines 61 to 63 extends corresponds to the column direction. In the following description, scan lines are denoted by the reference numeral 4 where they are collectively illustrated, and data signal lines are denoted by the reference numeral 6 where they are collectively illustrated.

A plurality of pixel display circuits 2 are grouped in such a manner that three pixel display circuits arranged in a matrix of one row and three columns belong to one group. Three pixel display circuits 2 belonging to each group are provided respectively with R, G, and B color filters (not shown).

Display unit 12 further includes a plurality of common potential lines 5 arranged for respective rows. To a plurality of common potential lines 5, a potential VS is applied.

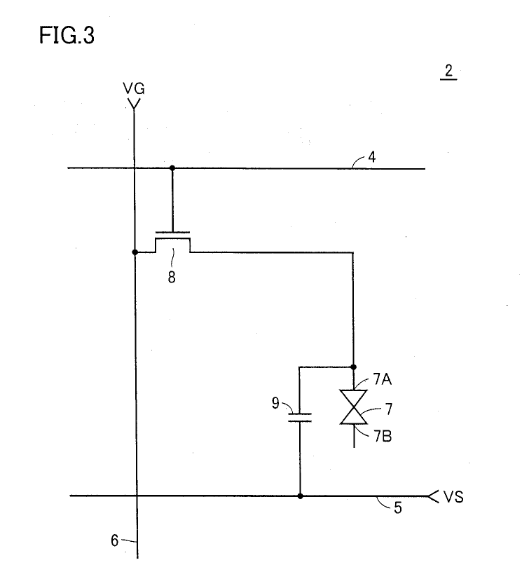

FIG. 3 is a schematic configuration diagram of pixel display circuit 2 shown in FIG. 2. Referring to FIG. 3, pixel display circuit 2 includes a liquid crystal cell 7, an N-type transistor 8, and a capacitor element 9. N-type transistor 8 is connected between data signal line 6 and one electrode 7A of liquid crystal cell 7. N-type transistor 8 has its gate connected to scan line 4.

Capacitor element 9 is connected between electrode 7A of liquid crystal cell 7 and common potential line 5. The other electrode 7B of liquid crystal cell 7 is connected to an opposite electrode (not shown) of the same potential as common potential line 5. A potential difference between electrodes 7A and 7B causes the liquid crystal orientation in liquid crystal cell 7 to change. Accordingly, the brightness of liquid crystal cell 7 is changed.

An analog pixel signal is transmitted through data signal line 6 and N-type transistor 8 to electrode 7A. Thus, the brightness of pixel display circuit 2 can be controlled. N-type transistor 8 is typically formed of an N-type polysilicon TFT. Capacitor element 9 maintains the potential difference between electrodes 7A and 7B in order to maintain the brightness of liquid crystal cell 7.

Referring back to FIG. 2, based on a control signal provided from signal terminal 17 or a control signal from a control circuit (not shown), scan line drive circuit 14 sequentially selects a plurality of scan lines 4 and applies a predetermined voltage to selected scan line 4. Application of a predetermined voltage to a scan line causes the voltage level of the scan line to be set to the high (H) level. In contrast, the voltage level of a non-selected scan line is kept at the low (L) level.

A change of the voltage level of scan line 4 from the L level to the H level /causes N-type transistor 8 shown in FIG. 3 to be turned on. Accordingly, electrode 7A of each liquid crystal cell 7 corresponding to this scan line 4 and data signal line 6 corresponding to this liquid crystal cell 7 are coupled.

While one scan line 4 is selected by scan line drive circuit 14, signal line drive circuit 13 outputs an analog data signal (namely gray level voltage VG) in parallel to a plurality of data signal lines 6. Gray level voltage VG is supplied to pixel display circuit 2 selected by scan line drive circuit 14 and signal line drive circuit 13, and held by capacitor element 9.

A period of time for which one scan line is selected by scan line drive circuit 14 is herein defined as “one horizontal period.” In the first embodiment, display unit 12 is driven in accordance with the so-called line sequential method. As all pixel display circuits 2 of liquid crystal panel 10 are scanned by scan line drive circuit 14 and signal line drive circuit 13, one image is displayed on display unit 12 of liquid crystal panel 10. “Image” is herein used as a collective term for picture, photograph, character, drawing, sign, and the like each made up of a plurality of pixels.

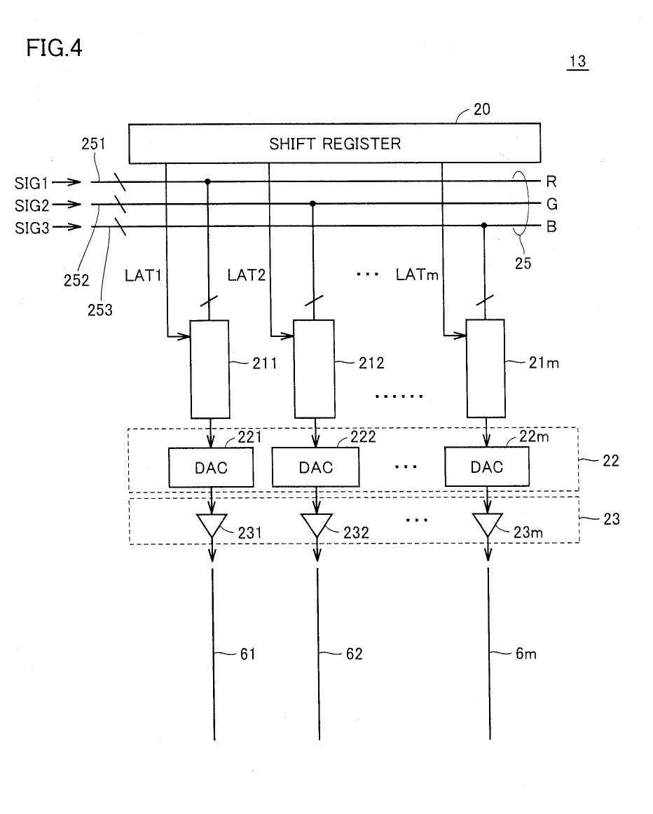

FIG. 4 is a block diagram showing a configuration of signal line drive circuit 13 shown in FIG. 1. Referring to FIG. 4, signal line drive circuit 13 includes a shift register 20, m (m is an integer of 2 or more, which is also applied hereinafter) latch circuits 211 to 21m provided correspondingly to columns respectively, a D/A conversion unit 22, and an output unit 23. D/A conversion unit 22 includes D/A converters (DAC) 221 to 22m provided correspondingly to latch circuits 211 to 21m, respectively. Output unit 23 includes output buffers 231 to 23m provided correspondingly to D/A converters 221 to 22m, respectively. As shown in FIG. 4, in the first embodiment, one latch circuit, one D/A converter, and one output buffer are provided for each column, namely each data signal line.

Shift register 20 sequentially outputs signals LAT1 to LATm. Signals LAT1 to LATm are each a single-phase signal. In response to signals LAT1 to LATm respectively, latch circuits 211 to 21m sample pixel data signals from a data bus 25 and latch the sampled pixel data. Pixel data for one row is sampled by latch circuits 211 to 21m for one horizontal period.

Pixel data signals SIG1 to SIG3 correspond to red data, green data, and blue data, respectively. The three pixel data signals are each a digital data signal made up of a plurality of bit data. Pixel data signals SIG1 to SIG 3 are input through signal terminal 17 shown in FIG. 1 to data bus 25. Data bus 25 includes buses 251 to 253 for transmitting pixel data signals SIG1 to SIG 3, respectively.

In the case for example where the display specification of liquid crystal panel 10 is 260-thousand-color display, it is necessary to display 64 gray levels for each of the three primary colors, red, green, and blue. Pixel data signals SIG1 to SIG3 are each constituted of six bits for display of 64 gray levels.

Buses 251 to 253 each include signal lines of the number corresponding to the number of bits of a pixel data signal of a corresponding color, in order to transmit the pixel data signal of the corresponding color. In the case where pixel data signals SIG1 to SIG3 are each constituted of 6-bit data, buses 251 to 253 each include six signal lines. It should be noted, however, that buses 251 to 253 are each illustrated as a single line in FIG. 4 for the sake of avoiding complication of the drawing.

In a retrace period, D/A converters 221 to 22m each convert the digital pixel data signal that is output from a corresponding latch circuit into an analog pixel data signal. Output buffers 231 to 23m output analog signals from corresponding D/A converters to data signal lines 61 to 6m, respectively. “Retrace period” herein means a horizontal retrace period, namely the period from the time when selection of a specific scan line by scan line drive circuit 14 ends to the time when selection of the subsequent scan line starts.

For the sake of convenience of description, the horizontal period and the retrace period are herein described as separate periods. In general, however, one horizontal period is often regarded as including the retrace period therein. In this case, in one horizontal period, a period for which one scan line is selected corresponds to “horizontal period” herein and the remaining period for example corresponds to “retrace period” herein.

In the configuration of the first embodiment, one D/A converter and one output buffer are arranged for each data signal line. Therefore, as described above, analog data signals can be output in parallel to a plurality of data signal lines 6. Namely, it is unnecessary to time-divide one horizontal period in order to output analog signals to all data signal lines. This drive method is herein referred to as “complete line sequential method.”

Latch circuits 211 to 21m have respective configurations and functions similar to each other. Therefore, the configuration and the function of latch circuit 211 will hereinafter be explained as representative ones.

FIG. 5 is a diagram for illustrating sampling and output of a pixel data signal by latch circuit 211 shown in FIG. 4. Referring to FIG. 5, bit data d0 to do constituting pixel data signal SIG1 are input respectively to input nodes I0 to In. Input nodes I0 to In are arranged along the column direction.

Latch circuit 211 has two operation modes. In a first mode, latch circuit 211 samples pixel data signal SIG1 in synchronization with a clock CK while signal LAT1 is the H level. At this time, latch circuit 211 obtains a plurality of bit data constituting pixel data signal SIG1 through input nodes I0 to In. In a second mode, latch circuit 211 sequentially outputs from output node OUT a plurality of bit data bit by bit in synchronization with clock CK while signal TRF is the H level. Namely, latch circuit 211 is a parallel-input serial-output type latch circuit.

Thus, latch circuit 211 alternately switches between the first mode and the second mode in response to signal LAT1 and signal TRF. Signal LAT1 is an output signal of shift register 20 and is a control signal that determines the sampling timing of the image data signal. Signal TRF and clock CK are input to latch circuit 211 from outside liquid crystal panel 10, for example. In order to restrict the number of lines, preferably signal LAT1, signal TRF, and clock CK controlling the operation of latch circuit 211 are each a single-phase signal.

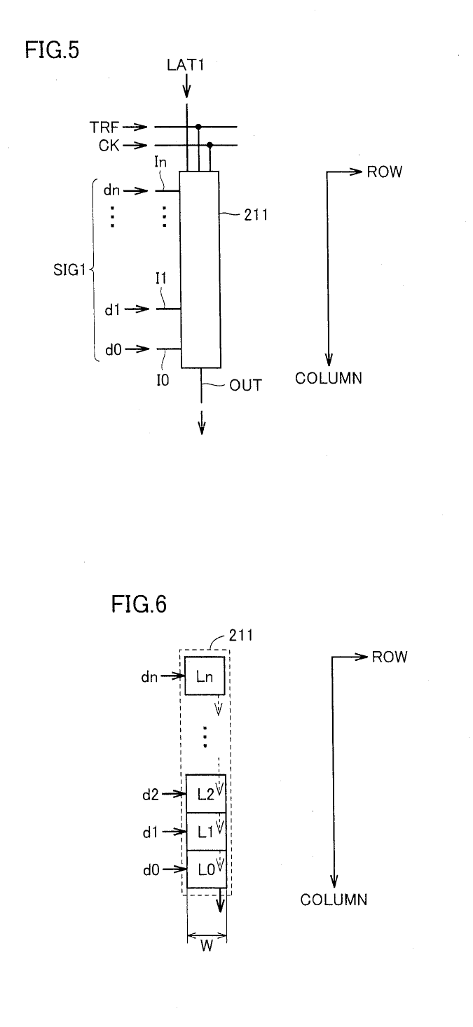

FIG. 6 is a diagram schematically illustrating a configuration of latch circuit 211 shown in FIG. 5. Referring to FIG. 6, latch circuit 211 includes a plurality of latch unit circuits L0 to Ln arranged in series in the column direction. The number of latch unit circuits included in one latch circuit is identical to the number of bits of the pixel data. Further, the length in the row direction (referred to as width W) of latch unit circuits L0 to Ln each is equal to or less than the pixel pitch in the row direction of display unit 12.

Latch unit circuits L0 to Ln each have two input paths and one output path. One of the two input paths is a path through which corresponding bit data of a plurality of bit data (d0 to dn) constituting the pixel data is input. This input path includes the above-described input node (I0 to In). The other of the two input paths is connected to the output path of the latch unit circuit in the preceding stage. Latch unit circuit Ln has no latch unit circuit in the preceding stage. Therefore, one of the two input paths of latch unit circuit Ln is connected for example to a ground voltage VSS. Further, the output path of latch unit circuit L0 is connected to output node OUT shown in FIG. 5.

Namely, at least one latch unit circuit (typically latch unit circuit L1) of latch unit circuits L0 to Ln has an output node for outputting one-bit data to the circuit in its subsequent stage (latch unit circuit L0), a first input node for receiving corresponding bit data of a plurality of bit data, and a second input node for receiving one-bit data from the circuit in its preceding stage (latch unit circuit L2).

Latch unit circuits L0 to Ln each latch one-bit data and transfer the one-bit data. Bit data dn is a most significant bit (MSB), and bit data d0 is a least significant bit (LSB). Latch unit circuits L0 to Ln each transfer one-bit data and thus a plurality of bit data held by latch circuit 211 are transferred to D/A converters in order from the least significant bit (LSB).

Respective configurations of latch unit circuits L0 to Ln are similar to each other. Each latch unit circuit is configured to transfer one-bit data in response to single-phase clock. In the following, a configuration of latch unit circuit L0 will be described as a representative one.

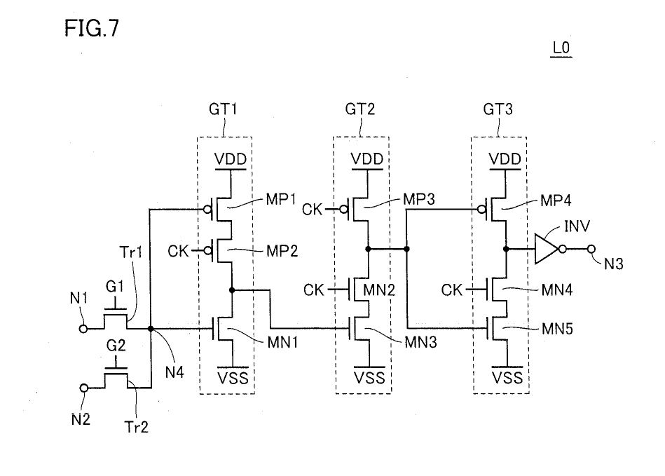

FIG. 7 is a circuit diagram showing an example configuration of the latch unit circuit shown in FIG. 6. Referring to FIG. 7, latch unit circuit L0 is a TSPC (True-Single-Phase-Clock)-type latch circuit.

Latch unit circuit L0 includes input nodes N1, N2, an output node N3, transistors Tr1, Tr2, gate circuits GT1 to GT3, and an inverter INV. Gate circuits GT1 to GT3 each include three transistors connected in series between ground voltage VSS and a power supply voltage VDD. Reference characters MP and MN respectively represent P-channel transistor and N-channel transistor.

Input node N1 of latch unit circuit L0 is connected to input node I0 to which bit data d0 is input. Input node N2 of latch unit circuit L0 is connected to output node N3 of the circuit in the preceding stage (namely latch unit circuit L1). Output node N3 of latch unit circuit L0 is connected to output node OUT shown in FIG. 5.

Transistor Tr1 is connected between input node N1 and a node N4 and turned on and off in response to a control signal G1. Transistor Tr2 is connected between input node N2 and node N4 and turned on and off in response to a control signal G2.

In the first embodiment, control signals G1 and G2 are signals LAT1 and TRF, respectively. In the case where control signal G1 (signal LAT1) causes transistor Tr1 to turn on, bit data d0 is input to gate circuit GT1. In contrast, when control signal G2 (signal TRF) causes transistor Tr2 to turn on, one-bit data is input from latch unit circuit L1 to gate circuit GT1. Namely, in latch unit circuit L0, control signals G1, G2 cause the two input paths to be switched to each other in turns.

Gate circuit GT1 includes transistors MP1, MP2, MN1 connected in series between ground voltage VSS and power supply voltage VDD. Respective control electrodes of transistors MP1, MN1 are both connected to node N4. Therefore, transistors MP1, MN1 are caused to complementarily turn on and off by a signal that is input to node N4. Transistor MP2 is caused to turn on and off by clock CK.

Gate circuit GT2 includes transistors MP3, MN2, MN3 connected in series between ground voltage VSS and power supply voltage VDD. Transistors MP3, MN2 are caused to complementarily turn on and off by clock CK. Transistor MN3 is caused to turn on and off by a signal that is output from gate circuit GT1.

Gate circuit GT3 includes transistors MP4, MN4, MN5 connected in series between ground voltage VSS and power supply voltage VDD. Transistors MP4, MN5 are caused to complementarily turn on and off by a signal that is output from gate circuit GT2. Transistor MN4 is caused to turn on and off by clock CK.

Inverter INV inverts the level of a signal that is output from gate circuit GT3. The output signal of inverter INV is transmitted to output node N3.

In gate circuit GT1, transistor MP2 is in the ON state while clock CK is the L level. In this case, gate circuit GT1 inverts the level of the data signal that is input to gate circuit GT1. For example, when the level of the input data signal is the L level, transistors MP1, MN1 are turned on and off respectively, and therefore, the level of the signal that is output from gate circuit GT1 is the H level. In contrast, when the level of the input data signal is the H level, transistors MP1, MN1 are turned off and on respectively, and therefore, the level of the signal that is output from gate circuit GT1 is the L level.

In gate circuit GT2, transistor MP3 is in the ON state while clock CK is the L level. Gate circuit GT2 outputs an H level signal while clock CK is the L level. In contrast, while clock CK is the H level, transistor MP3 and transistor MN2 are in the OFF state and the ON state respectively. In this case, gate circuit GT2 inverts the level of the signal that is output from gate circuit GT1. In the case where the level of the signal that is output from gate circuit GT1 is the H level, transistor MN3 is in the ON state, and thus the level of the signal that is output from gate circuit GT2 is the L level. In contrast, in the case where the level of the signal that is output from gate circuit GT1 is the L level, transistor MN3 is in the OFF state, and thus the level of the signal that is output from gate circuit GT2 is the H level.

In gate circuit GT3, while clock CK is the L level, transistor MN4 is in the OFF state. Therefore, while clock CK is the L level, gate circuit GT3 is not activated. In contrast, while clock CK is the H level, transistor MN4 is in the ON state, and thus transistors MP4 and MN5 constitute an inverter. In this case, gate circuit GT3 inverts the level of the signal that is output from gate circuit GT2.

While clock CK is the L level, although the level of the data signal that is input to gate circuit GT1 influences the signal that is output from gate circuit GT1, it does not influence the signal that is output from inverter INV. As the level of clock CK changes from the L level to the H level, gate circuits GT2, GT3 operate as inverters, and therefore, a data signal of the same level as the data signal that has been input to gate circuit GT1 is output from inverter INV. Namely, latch unit circuit L0 outputs the same data as the input data.

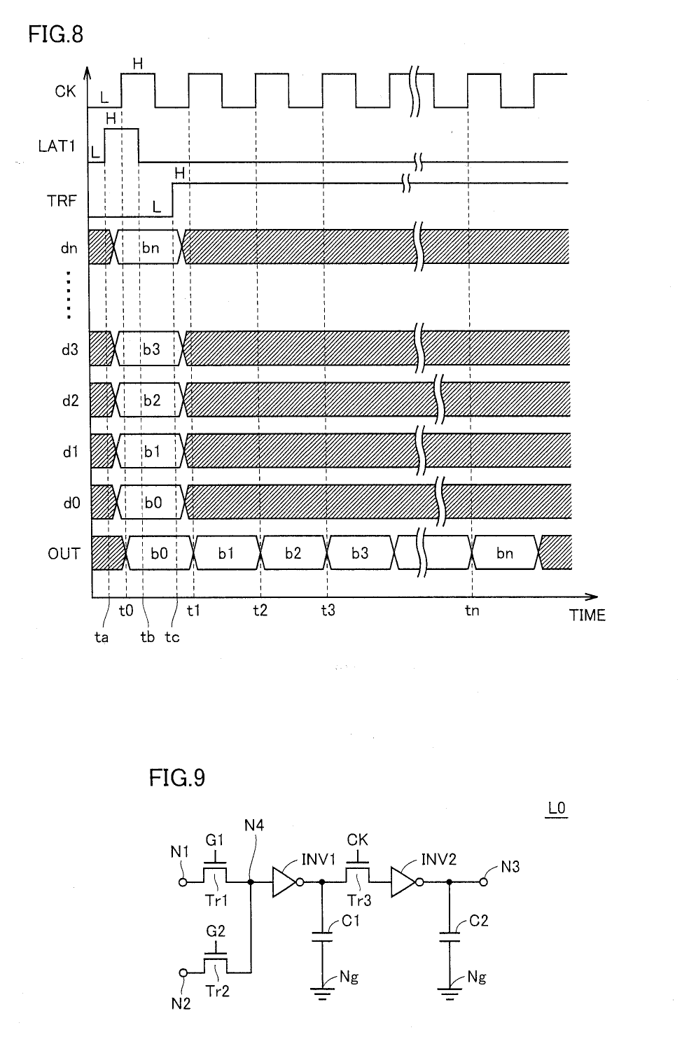

FIG. 8 is a timing chart showing operation waveforms of latch circuit 211 made up of the latch unit circuits shown in FIG. 7. Referring to FIG. 8, at time ta, the level of signal LAT1 changes from the L level to the H level. Accordingly, respective transistors Tr1 of latch unit circuits L0 to Ln are turned on. Namely, the operation mode of latch unit circuits L0 to Ln each is set to the first mode.

At time t0, the level of clock CK changes from the L level to the H level. Accordingly, latch unit circuits L0 to Ln latch bit data d0 to dn, respectively. Namely, latch circuit 211 obtain a plurality of bit data at a time. Bit data b0 to bn are bit data held respectively by latch unit circuits L0 to Ln. Bit bn is a most significant bit (MSB) and bit b0 is a least significant bit (LSB). Bit b0 is taken by latch unit circuit L0 at time t0, and output from latch unit circuit L0 (output node OUT of latch circuit 211).

At time tb, the level of signal LAT1 changes from the H level to the L level. Accordingly, respective transistors Tr1 of latch unit circuits L0 to Ln are turned off At time tc, the level of signal TRF changes from the L level to the H level. Accordingly, respective transistors Tr2 of latch unit circuits L0 to Ln are turned on. Namely, at time tc, the operation mode of latch unit circuits L0 to Ln each switches from the first mode to the second mode.

After time tc, each time clock CK rises, latch unit circuits L0 to Ln each transfer one-bit data. Latch circuit 211 outputs bits b1, b2, b3 . . . bn at time t1, t2, t3 . . . tn, respectively. At time tn, latch circuit 211 outputs bit bn, and thus transfer of the pixel data by latch circuit 211 ends. Until latch circuit 211 outputs bits b1 to bn, signal TRF is kept at the H level.

FIG. 9 is a circuit diagram showing another example configuration of the latch unit circuit shown in FIG. 6. Referring to FIG. 9, latch unit circuit L0 is a kind of latch circuit called dynamic latch. Latch unit circuit L0 includes input nodes N1, N2, an output node N3, transistors Tr1, Tr2, a transistor Tr3, inverters INV1, INV2, and capacitors C1, C2.

Like the configuration shown in FIG. 7, transistor Tr1 is connected between input node N1 and a node N4, and transistor Tr2 is connected between input node N2 and node N4. Transistor Tr1 is turned on and off in response to control signal G1 and transistor Tr2 is turned on and off in response to control signal G2. In the first embodiment, control signals G1 and G2 are signals LAT1 and TRF, respectively.

Inverter INV1 inverts the level of a signal that is input to node N4. Transistor Tr3 is connected between the output node of inverter INV1 and the input node of inverter INV2 and turned on and off in response to clock CK. The output node of inverter INV2 is connected to output node N3. Capacitor C1 is connected between the output node of inverter INV1 and a ground node Ng. Capacitor C2 is connected between the output node (output node N3) of inverter INV2 and ground node Ng.

In the present embodiment, transistor Tr3 is an N-channel transistor, and turned on when the level of clock CK changes from the L level to the H level. As transistor Tr3 is turned on, the output node of inverter INV1 and the input node of inverter INV2 are coupled, and accordingly, a signal of the same level as the level of the signal that has been input to inverter INV1 is output from output node N3. Namely, the data that is input to node N4 through transistor Tr1 or Tr2 is output from output node N3.

In contrast, as the level of clock CK changes from the H level to the L level, transistor Tr3 is turned off. In this case, capacitor C1 holds the voltage of the output node of inverter INV1, and capacitor C2 holds the voltage of the output node of inverter INV2. Namely, the state of the latch unit circuits remains unchanged.

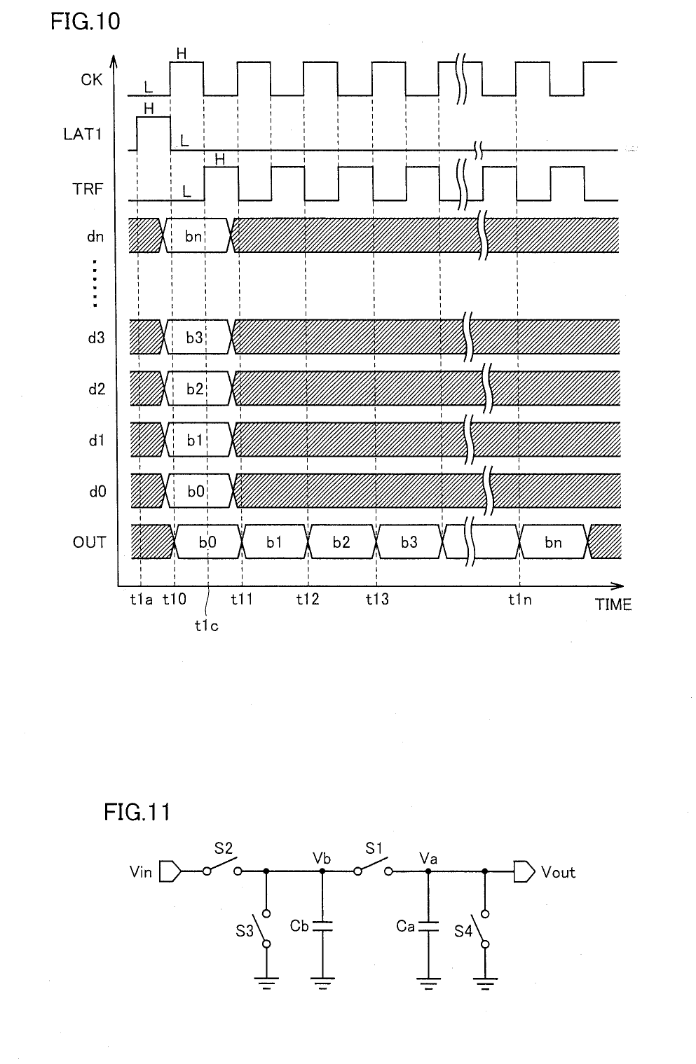

FIG. 10 is a timing chart showing operation waveforms of latch circuit 211 made up of the latch unit circuits shown in FIG. 9. Referring to FIG. 10, at time t1a, the level of signal LAT1 changes from the L level to the H level. Accordingly, respective transistors Tr1 of latch unit circuits L0 to Ln are turned on. Namely, the operation mode of latch unit circuits L0 to Ln each is set to the first mode.

At time t10, the level of clock CK changes from the L level to the H level. Accordingly, latch unit circuits L0 to Ln latch bit data d0 to dn, respectively. Bits b0 to bn are bit data held respectively by latch unit circuits L0 to Ln. Bit b0 is taken by latch unit circuit L0 at time t10 and output from latch unit circuit L0 (output node OUT of latch circuit 211). Further, at time t10, the level of signal LAT1 changes from the H level to the L level. Accordingly, respective transistors Tr1 of latch unit circuits L0 to Ln are turned off.

Signal TRF changes in synchronization with clock CK. The level of signal TRF changes oppositely to the level of clock CK. Namely, as the level of clock CK changes from the L level to the H level, the level of signal TRF changes from the H level to the L level. In contrast, as the level of clock CK changes from the H level to the L level, the level of signal TRF changes from the L level to the H level.

At time tic, the operation mode of latch unit circuits L0 to Ln each switches from the first mode to the second mode. Latch circuit 211 sequentially transfers a plurality of bit data based on signal TRF and clock CK.

The change of the level of signal TRF from the L level to the H level causes respective transistors Tr2 of latch unit circuits L0 to Ln to be turned on. Accordingly, latch unit circuits L0 to Ln each obtain one-bit data from the circuit in the preceding stage. Meanwhile, as the level of clock CK changes from the H level to the L level, transistor Tr3 is turned off Therefore, latch unit circuits L0 to Ln each hold respective data.

The change of the level of signal TRF from the H level to the L level causes respective transistors Tr2 of latch unit circuits L0 to Ln to be turned off. Meanwhile, as the level of clock CK changes from the L level to the H level, transistor Tr3 is turned on. Accordingly, latch unit circuits L0 to Ln each transfer one-bit data.

At time t1c, each of latch unit circuits L0 to Ln-1 obtains one-bit data from the circuit in its preceding stage. At time t11, latch unit circuits L0 to Ln-1 each transfer its data held therein. Thus, bit b1 is output from output node OUT of latch circuit 211. Latch circuit 211 repeats the above-described operation to thereby output bits b2, b3 . . . bn at time t12, t13 . . . t1n, respectively.

Latch circuits 211 to 21n each output pixel data bit by bit. The present embodiment therefore employs serial-input-type D/A converters. For example, cyclic-type D/A converters may be applied as D/A converters in the present embodiment.

FIG. 11 is a diagram conceptually showing a configuration of a cyclic-type D/A converter applicable to embodiments of the present invention. Referring to FIG. 11, the cyclic-type D/A converter includes capacitors Ca, Cb and switches S1 to S4. Capacitors Ca, Cb are formed for example so that they have respective capacitance values equal to each other.

Before a data signal is input to the D/A converter, switches S1 and S2 are both turned off and switches S3 and S4 are turned on. Capacitors Ca, Cb are discharged and output voltage Vout of the D/A converter becomes zero.

Then, switches S3 and S4 are turned off and switches S1 and S2 are complementarily turned on and off. When switch S2 is ON, a voltage Vin corresponding to the H level or a voltage Vin corresponding to the L level is input to the D/A converter and applied to capacitor Cb. In contrast, when switch S1 is ON, electric charges are redistributed between capacitors Ca and Cb.

The voltage applied to capacitor Cb is a voltage V1 when the bit data that is input to the D/A converter is “1.” In contrast, when the bit data that is input to the D/A converter is “0,” the voltage applied to capacitor Cb is zero.

It is supposed for example that serially-input data is 4-bit digital data represented by (1001). As switch S2 is turned on, “1” which is the least significant bit (LSB) is input to the D/A converter. At this time, voltage Vb on one end of capacitor Cb is V1. Then, switch S2 is turned off and switch S1 is turned on. Accordingly, electric charges are redistributed between capacitors Ca and Cb. Thus, voltage Vb is V1/2.

Switch S2 is then turned on to cause the second bit “0” to be input to the D/A converter. At this time, voltage Vb is zero. Meanwhile, voltage Va is kept at V1/2. After this, switch S2 is turned off and switch S1 is turned on. Accordingly, electric charges are redistributed between capacitors Ca and Cb and voltages Va and Vb become equal to each other. Voltages Va and Vb at this time are represented by a formula (1) below.

Va=Vb= 1/2×(0×V1+½×V1)=V1/4 (1)

Switch S2 is then turned on to cause the third bit “0” to be input to the D/A converter and cause voltage Vb to become zero. After this, switch S2 is turned off and switch S1 is turned on. Accordingly, electric charges are redistributed between capacitors Ca and Cb.

Subsequently, switch S2 is turned on to cause the most significant bit “1” to be input to the D/A converter and cause voltage Vb to become V1. After this, switch S2 is turned off and switch S1 is turned on. Accordingly, electric charges are redistributed between capacitors Ca and Cb. Voltages Va and Vb at this time are represented by a formula (2) below.

Va=Vb=½×1+(½)²×0+(½)³×0+(½)⁴×1}×V1=( 9/16) V1 (2)

Thus, voltage Vout corresponding to the digital data (1001) input to the D/A converter is generated by the D/A converter.

According to the present embodiment, the latch circuit of each column is a serial-output-type latch circuit, The length in the row direction of the latch circuit can therefore be reduced. In contrast, in the case of a parallel-output-type latch circuit, it is not easy to reduce the length in the row direction of the latch circuit. This will be explained based on examples to be considered in connection with the present embodiment as well as the present embodiment.

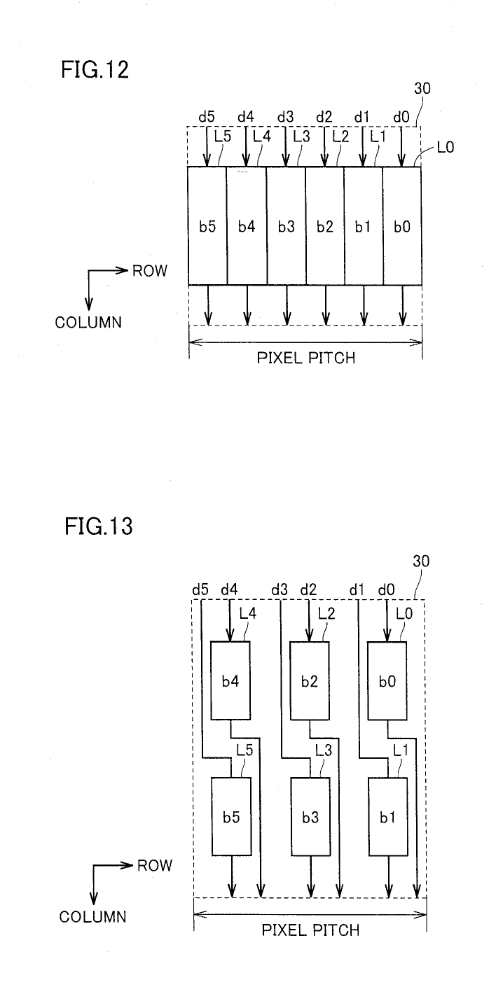

FIG. 12 is a diagram showing a first example to be considered of the configuration of the latch circuit. Referring to FIG. 12, the latch circuit includes latch unit circuits L0 to L5 arranged along the row direction.

Regarding the configuration shown in FIG. 12, the length in the row direction of the region of one latch circuit (latch region 30) in the frame region is determined by the product of the length in the row direction of one latch unit circuit and the number of the latch unit circuits. Therefore, the pixel pitch in the row direction of the display unit is restricted by the length in the row direction of the region of one latch circuit (latch region 30) in the frame region. In the case where the pixel pitch is small, a plurality of latch circuits that are provided for respective columns cannot be arranged along the row direction.

FIG. 13 is a diagram showing a second example to be considered of the configuration of the latch circuit. Referring to FIG. 13, latch unit circuits L0 to L5 are arranged in a matrix of three rows and two columns. However, because signals for transferring bit data that are output from respective latch unit circuits are arranged along the row direction, it is difficult to reduce the length in the row direction of latch region 30. Therefore, like the first example to be considered, in the case where the pixel pitch is small, a plurality of latch circuits provided for respective columns cannot be arranged along the row direction.

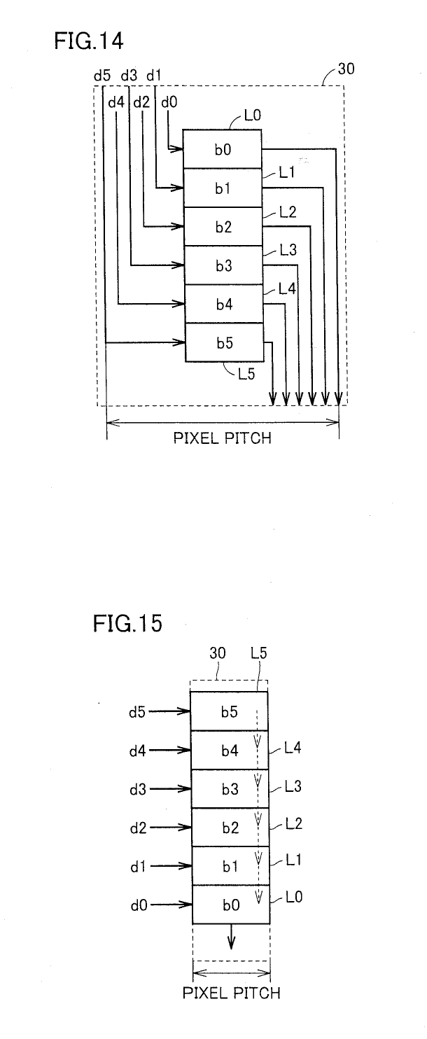

FIG. 14 is a diagram showing a third example to be considered of the configuration of the latch circuit. Referring to FIG. 14, the latch circuit includes latch unit circuits L0 to L5 arranged in a matrix of one row and six columns. Like the first and second examples to be considered, the signal lines for transferring bit data that are output from respective latch unit circuits are arranged along the row direction. Therefore, in the case where the pixel pitch is small, a plurality of latch circuits provided for respective columns cannot be arranged along the row direction.

As shown in FIGS. 12 to 14, in the case where the latch circuit is configured so that a plurality of bit data are output in parallel, a plurality of signal lines are necessary for transferring respective bit data. A plurality of signal lines are arranged along the row direction. As a result, the length in the row direction of the latch region is accordingly large.

FIG. 15 is a diagram showing an arrangement of the latch unit circuits in the first embodiment. Referring to FIG. 15, the latch circuit includes latch unit circuits L0 to L5 arranged in a matrix of one row and six columns. Latch unit circuits L1 to L5 transfer one-bit data to the latch circuit in the subsequent stage. Latch unit circuit L0 transfers the data from latch unit circuit L1 to the D/A converter. According to the present embodiment, the data from the latch circuit is transferred by a single signal line. The length in the row direction of latch region 30 is determined by the length in the row direction of one latch unit circuit. As a result, even if the pixel pitch is small, a plurality of latch circuits can be arranged along the row direction.

In the present embodiment, the transistors that are constituent components of the latch unit circuit are each formed of a polycrystalline silicon (p-Si) TFT. Therefore, the latch unit circuit can be formed so that the length in the row direction (width W shown in FIG. 6) of the latch unit circuit is equal to or less than the pixel pitch.

Further, as shown in FIGS. 8 and 10, clock CK and signal TRF that are input to the latch circuit are each a single-phase signal. Therefore, as shown in the drawings such as FIGS. 5, 7, and 9, the number of signal lines required for transmitting clock CK and the number of signal lines required for transmitting signal TRF are both one. The present embodiment can control the latch circuit with a small number of signal lines. Namely, the region where the control lines transmitting signals for controlling the latch circuit are arranged can be made small.

A smaller pixel pitch enables the resolution of the liquid crystal panel to be enhanced. The present embodiment can thus implement a liquid crystal panel into which a high-resolution display unit and a drive circuit for driving the display unit are integrated.

The D/A converter in the present embodiment is a D/A converter having a linear input/output characteristic (so-called linear DAC). In the case where a gamma correction is made for optical characteristics of liquid crystal, a pixel data signal having undergone the gamma correction by a circuit external to the liquid crystal panel is input through signal terminal 17 to signal line drive circuit 13.

The above-described gamma correction refers to adjustment of the relation between original pixel data and the gray level voltage (analog signal), in order to provide more natural display. For example, a 6-bit pixel data signal is converted in advance to 8-bit data by means of a lookup table or the like. To the liquid crystal panel, the 8-bit pixel data signal is input.

Latch circuits 211 to 21m each include eight latch unit circuits. Each latch circuit obtains 8-bit pixel data and transfers the data to the D/A converter. The D/A converter converts the 8-bit digital data that is output from its corresponding latch circuit to thereby generate an analog signal.

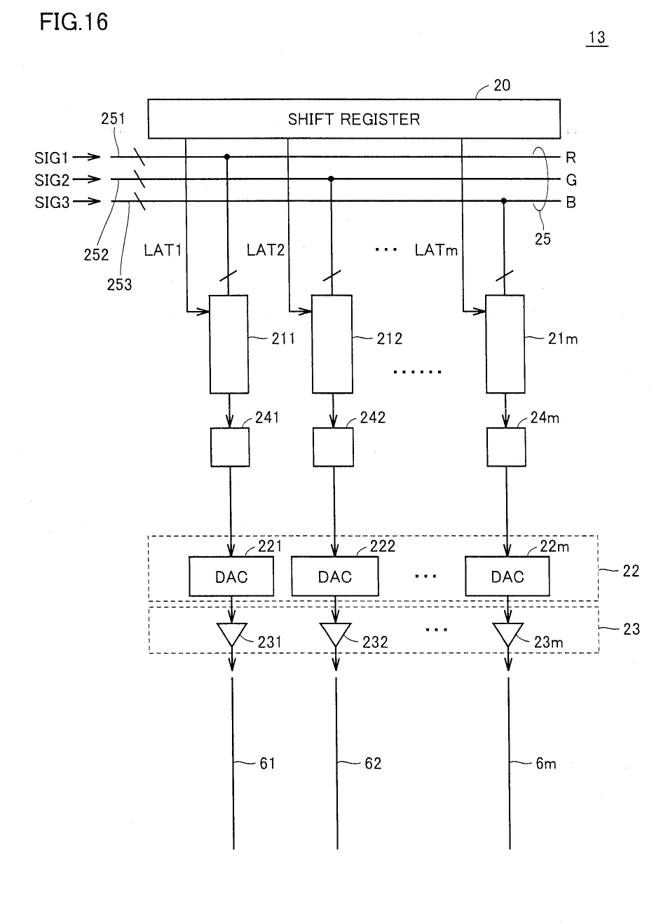

In the case where the operating voltage of the latch circuit and the operating voltage of the D/A converter are different from each other, a level shift circuit is necessary. In this case, as shown in FIG. 16, level shift circuits 242 to 24m are provided correspondingly to latch circuits 211 to 21m. Each level shift circuit adjusts the level of the amplitude voltage of a digital data signal from the corresponding latch circuit, for digital to analog conversion by the D/A converter. For example, each level shift circuit converts the amplitude voltage of the signal from 3 V to 5 V.

In the configuration of the present embodiment, output from latch circuits 211 to 21m is based on the serial operation, and therefore, it is sufficient for the level shift circuit to adjust the level of the amplitude voltage of one-bit data. The size of the level shift circuit can therefore be reduced. The present embodiment can implement a liquid crystal panel into which a high-resolution display unit and a drive circuit are integrated, even if the level shift circuit is necessary.

### Second Embodiment

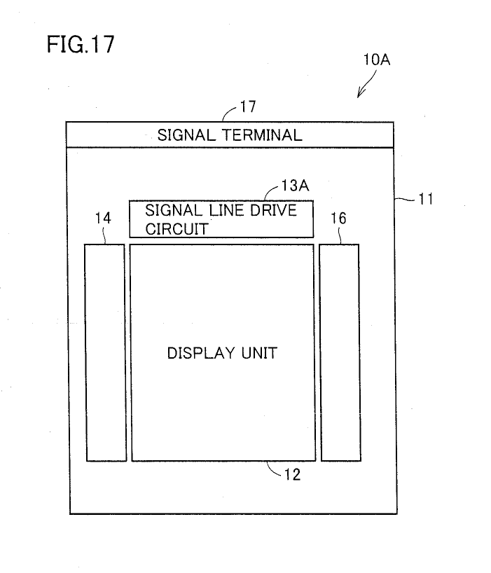

FIG. 17 is a block diagram showing an example configuration of a display device including a drive circuit according to a second embodiment. Referring to FIGS. 17 and 1, a liquid crystal panel 10A differs from liquid crystal panel 10 in that the former includes a signal line drive circuit 13A instead of signal line drive circuit 13. The configurations of other components of liquid crystal panel 10A are similar to the configurations of the corresponding components of liquid crystal panel 10, and therefore, the description thereof will not be repeated.

In the second embodiment, signal line drive circuit 13A selects one of R (red) data, G (green) data, and B (blue) data in a time-division manner in one horizontal period, and outputs the selected data to a corresponding data signal line. The drive method in the second embodiment is also the line sequential method. For distinguishing the drive method in the first embodiment and the drive method in the second embodiment from each other, the drive method in the second embodiment will hereinafter be referred to as “RGB selector method.”

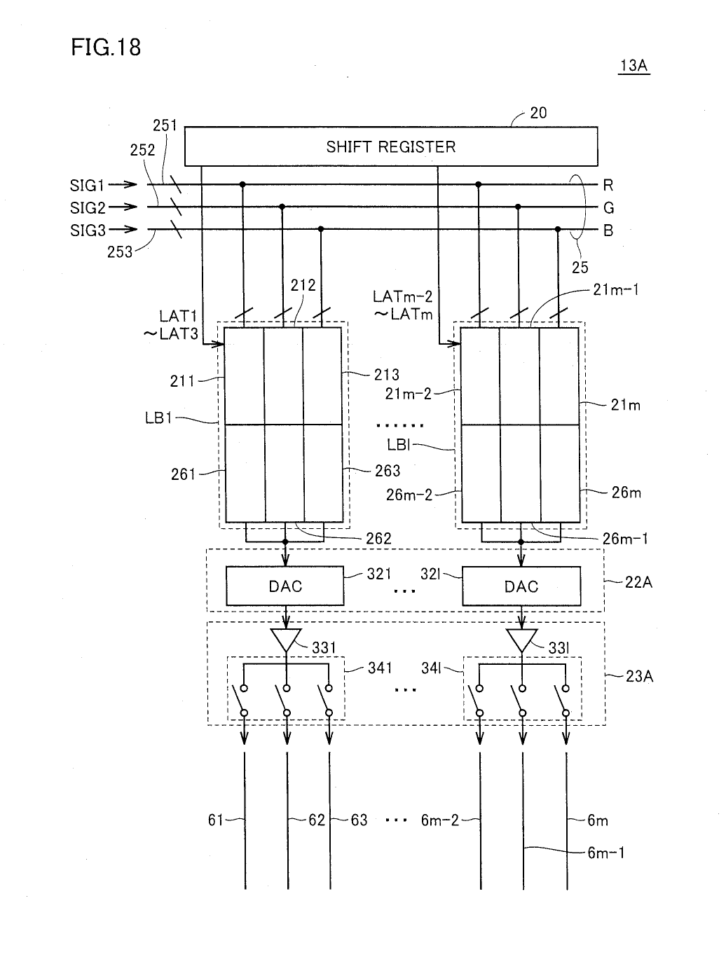

FIG. 18 is a block diagram showing a configuration of signal line drive circuit 13A shown in FIG. 17. Referring to FIGS. 18 and 4, signal line drive circuit 13A differs from signal line drive circuit 13 in that the former further includes latch circuits 261 to 26m provided correspondingly to latch circuits 211 to 21m, respectively. Namely, in the present embodiment, latch circuits in two stages respectively are provided for one column. The two-stage latch circuits constitute “latch circuit” of the present invention.

The two-stage latch circuits in which the latch circuits are connected in series to each other are grouped in advance in such a manner that the latch circuits in three columns constitute one group. This group will be referred to as “latch block” hereinafter. Latch circuits 211 to 21m and 261 to 26m are grouped into l latch blocks LB1 to LBl, where l is an integer satisfying l=m/3.

Latch circuits 211, 212, 213 . . . 21m-2, 21m-1, 21m receive respective signals LAT1, LAT2, LAT3 . . . LATm-2, LATm-1, LATm from shift register 20. The two-stage latch circuits corresponding to one column obtain a pixel data signal from a corresponding bus of buses 251 to 253, and transfer the pixel data signal. For example, the two-stage latch circuits belonging to a first column obtain pixel data signal SIG1 (R data) from bus 251, in response to a signal from shift register 20. The two-stage latch circuits belonging to a second column obtain pixel data signal SIG2 (G data) from bus 252, in response to a signal from shift register 20. The two-stage latch circuits belonging to a third column obtain pixel data signal SIG3 (B data) from bus 253, in response to a signal from shift register 20.

Further, signal line drive circuit 13A differs from signal line drive circuit 13 in that the former includes a D/A conversion unit 22A instead of D/A conversion unit 22. D/A conversion unit 22A includes D/A converters 321 to 32m provided correspondingly to latch blocks LB1 to LBl, respectively. D/A converters 321 to 32m each convert the pixel data signal that is output from its corresponding latch block into an analog signal. In the second embodiment like the first embodiment, a serial-input-type D/A converter (cyclic-type D/A converter for example) is applied.

Furthermore, signal line drive circuit 13A differs from signal line drive circuit 13 in that the former includes an output unit 23A instead of output unit 23. Output unit 23A includes output buffers 331 to 33m provided correspondingly to D/A converters 321 to 32m, respectively. Output unit 23A further includes line selectors 341 to 34m provided correspondingly to output buffers 331 to 33m, respectively.

Output unit 23A selects, in a time-division manner, one of the analog pixel data signals (R data, G data, and B data) that are output from D/A converters 321 to 32m each, and outputs the selected signal to a corresponding signal line. For example, when an analog R data signal is output from D/A converter 321, line selector 341 selects data signal line 61. The analog R data that is output from D/A converter 321 is supplied through output buffer 331 and line selector 341 to data signal line 61.

When an analog G data signal is output from D/A converter 321, line selector 341 selects data signal line 62. The analog G data that is output from D/A converter 321 is supplied through output buffer 331 and line selector 341 to data signal line 62.

When an analog B data signal is output from D/A converter 321, line selector 341 selects data signal line 63. The analog B data that is output from D/A converter 321 is supplied through output buffer 331 and line selector 341 to data signal line 63.

Latch blocks LB 1 to LB/ have respective configurations similar to each other. Further, latch circuits 211 to 21m have respective configurations similar to each other. Latch circuits 211 to 21m each have the configuration shown in FIGS. 5 and 6. Further, latch circuits 211 to 21m are each constituted of the latch unit circuits shown in FIG. 7 or FIG. 9. Therefore, the description about the configuration of latch circuits 211 to 21m each will not be repeated in principle.

In the present embodiment, latch circuits 261 to 26m have respective configurations similar to each other. Therefore, in the following, the configuration of latch circuit 261 will be described as a representative one.

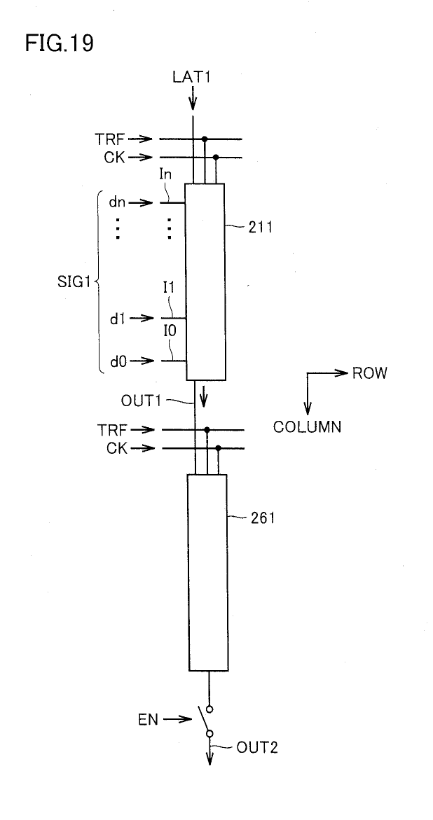

FIG. 19 is a diagram for illustrating input and output of latch circuits 211, 261. Referring to FIG. 19, latch circuit 211 receives signals LAT1, TRF, clock CK, and bit data d0 to do that constitute pixel data signal SIG1. Latch circuit 211 is a parallel-input serial-output type latch circuit, and sequentially outputs a plurality of bit data bit by bit from an output node OUT1.

Latch circuit 261 is a serial-input serial-output type latch circuit. Latch circuit 261 latches the data from latch circuit 211 and outputs the data bit by bit from an output node OUT2. While TRF is the H level, latch circuit 261 takes in one-bit data or sequentially transfers data in response to clock CK. A signal EN is preferably a single-phase signal and is for example input from outside liquid crystal panel 10A to liquid crystal panel 10A.

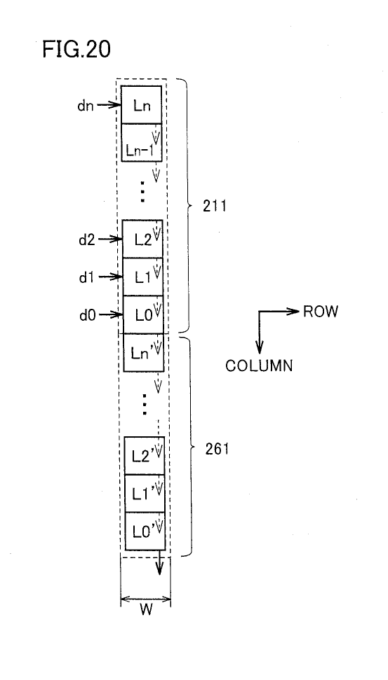

FIG. 20 is a diagram schematically illustrating the configuration of latch circuits 211, 261 shown in FIG. 19. Referring to FIG. 20, latch circuits 211, 261 are arranged in series in the column direction. Latch circuit 211 includes a plurality of latch unit circuits L0 to Ln arranged in series in the column direction. Latch circuit 261 includes a plurality of latch unit circuits L0′ to Ln′ arranged in series in the column direction. The number of latch unit circuits included in latch circuit 211 and the number of latch unit circuits included in latch circuit 261 are each equal to the number of bits of pixel data. Length W in the row direction of each of latch unit circuits L0 to Ln, L0′ to Ln′ is equal to or less than the pixel pitch.

Latch unit circuits L0 to Ln each have two input paths and one output path. In contrast, latch unit circuits L0′ to Ln′ each have one input path and one output path. Latch unit circuits L0 to Ln, L0′ to Ln′ each latch data of one bit and transfer the bit data. Latch unit circuits L0 to Ln, L0′ to Ln′ have respective configurations similar to each other. Latch unit circuits L0 to Ln each have the configuration shown in FIG. 7 or 9.

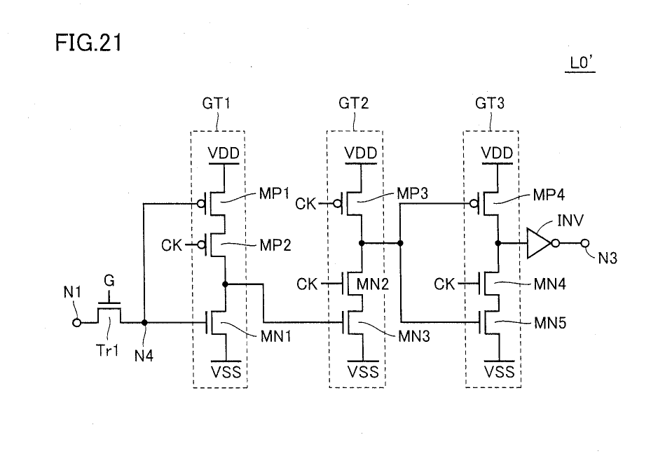

FIG. 21 is a circuit diagram showing a configuration of latch unit circuit L0′ shown in FIG. 20. Referring to FIGS. 21 and 7, since latch unit circuit L0′ has only one input path, transistor Tr1 is connected between input node N1 and node N4. In this respect, latch unit circuit L0′ differs from latch unit circuit L0. Transistor Tr1 is turned on and off in response to control signal G. In the second embodiment, control signal G corresponds to signal TRF. Latch unit circuits L0′ to Ln′ are connected in series in such a manner that output node N3 of the latch unit circuit in the preceding stage is connected to input node N1 of the latch unit circuit in the subsequent stage.

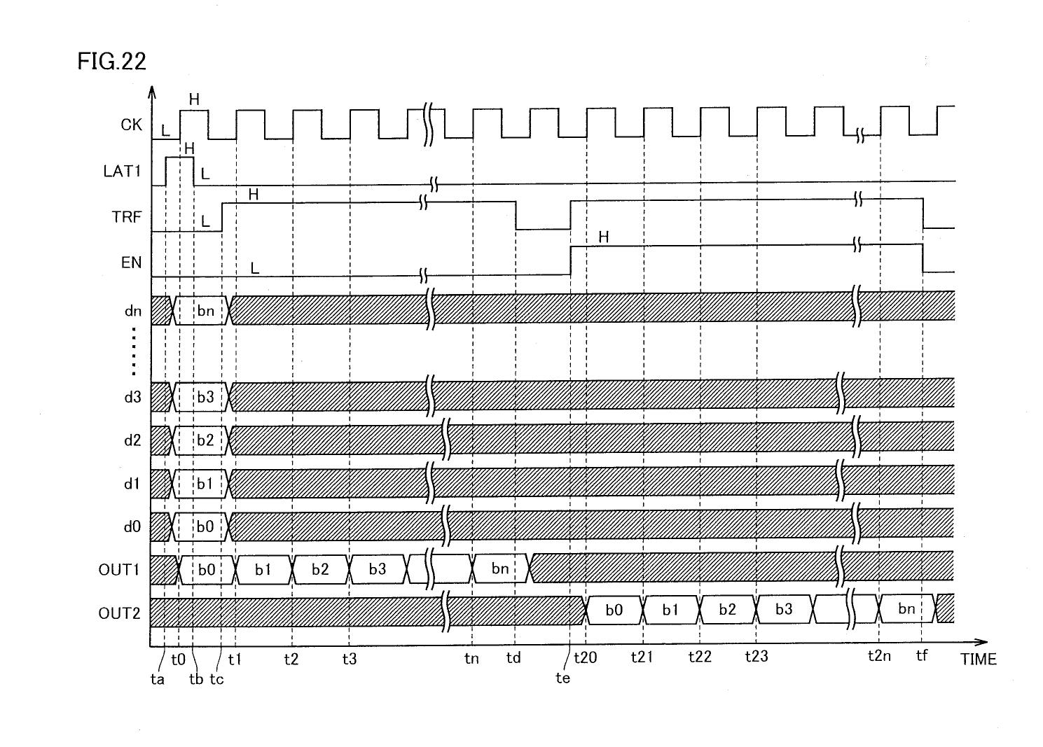

FIG. 22 is a timing chart showing operation waveforms of latch circuits 211, 261 shown in FIGS. 20 and 21.

Referring to FIGS. 22 and 8, the operation of latch circuit 211 in the period from time ta to time to shown in FIG. 22 is similar to the operation of latch circuit 211 in the first embodiment. During the period from time ta to time te, the level of signal EN is kept at the L level. In response to clock CK, latch circuit 261 latches a plurality of bit data that are sequentially output from latch circuit 211.

At time tn, from output node OUT1 of latch circuit 211, bit bn which is the most significant bit is output. At time td, the level of signal TRF changes from the H level to the L level. Accordingly, transfer of the data from latch circuit 211 to latch circuit 261 ends.

Latch circuit 211 sequentially transfers a plurality of bit data bit by bit to latch circuit 261, based on signal TRF and clock CK. In order to transfer n-bit data, a period of time corresponding to n cycles of clock CK is necessary. At time te, the level of signal TRF changes from the L level to the H level and the level of signal EN changes from the L level to the H level.

Latch circuit 261 sequentially transfers a plurality of bit data bit by bit to D/A converter 321, in synchronization with clock CK, while signal TRF and signal EN are at the H level. The n-bit data are transferred in order from the least significant bit (LSB) to the D/A converter. First, at time t20, the level of clock CK changes from the L level to the H level to cause latch circuit 261 to output bit b0. After this, each time the level of clock CK changes from the L level to the H level, latch circuit 261 outputs one-bit data. Latch circuit 261 outputs bits b1, b2, b3 bn at time t21, t22, t23 t2n, respectively. After this, respective levels of signal TRF and signal EN each change from the H level to the L level at time tf.

Signal TRF and signal EN for controlling latch circuits 261 to 26m are signals that are provided for each of three independent systems corresponding respectively to R, G, and B. Signals of each system are input to a corresponding latch circuit of latch circuits 261 to 26m to thereby enable a time-division operation.

Like the first embodiment, latch unit circuits L0 to Ln each may be a dynamic latch having the configuration shown in FIG. 9. In this case, latch unit circuits L0′ to Ln′ each have a configuration similar to the configuration shown in FIG. 9 except that the number of input transistors is one.

As shown in FIG. 22, n-bit data are sampled simultaneously by latch circuit 211 based on signal LAT1 that is output from shift register 20. Latch circuits 211 to 21m sample data in one horizontal period, and transfer the data to latch circuit 261 in a retrace period.

In the subsequent one horizontal period, latch circuit 261 transfers the data to D/A converter 321, and D/A converter 321 converts the data into an analog signal. The analog signal from D/A converter 321 is output to the corresponding signal line by output buffer 331 and line selector 341.

In the second embodiment, latch circuits 211 to 21 m each include a plurality of latch unit circuits arranged in series in the column direction. Likewise, latch circuits 261 to 26m each also include a plurality of latch unit circuits arranged in series in the column direction. The length in the row direction of these latch unit circuits each is equal to or less than the pixel pitch in the row direction of display unit 12. Thus, the second embodiment can implement a liquid crystal panel into which a high-resolution display unit and a drive circuit are integrated, similarly to the first embodiment.

Further, in the second embodiment, two-stage latch circuits are provided for one column. Accordingly, in one horizontal period, rather than a retrace period, digital to analog conversion can be performed by the D/A converter.

In order to obtain an analog voltage of high precision by the digital to analog conversion, a period of time for sufficiently stabilizing the analog voltage is necessary. In the second embodiment, D/A converters 321 to 32m each perform digital to analog conversion in one horizontal period. The precision of the analog voltage that is output from each D/A converter can thus be enhanced.

In the present embodiment, a serial-type DAC is employed. For a liquid crystal panel of multi-gray-level display, namely a liquid crystal panel displaying an image by pixel data signals made up of multiple bits, a method of performing digital to analog conversion by taking one horizontal period is preferable for ensuring high-quality display. Namely, the second embodiment can implement high-quality display even if the display specification requires both the high definition and high operation drive frequency.

Further, in the present embodiment, each latch block transfers data to the D/A converter following the RGB selector method. The present embodiment can thus reduce the number of D/A converters and output buffers.

### Third Embodiment

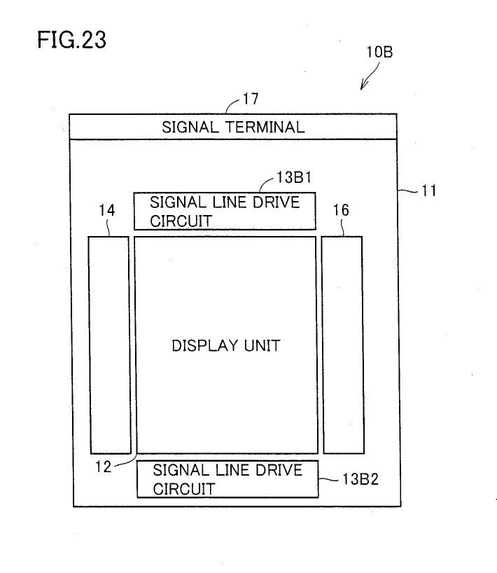

FIG. 23 is a block diagram showing an example configuration of a display device including a drive circuit according to a third embodiment. Referring to FIGS. 23 and 1, a liquid crystal panel 10B differs from liquid crystal panel 10 in that the former includes signal line drive circuits 13B1, 13B2 instead of signal line drive circuit 13. Configurations of other components of liquid crystal panel 10B are similar to the configurations of the corresponding components of liquid crystal panel 10, and therefore, the description thereof will not be repeated.

In the third embodiment, signal line drive circuits 13B1, 13B2 are arranged along the column direction so that they sandwich display unit 12 therebetween. A plurality of signal lines are grouped in such a manner that three signal lines for transferring R data, G data, and B data respectively constitute one group. Signal line drive circuits 13B1, 13B2 respectively drive one and the other of signal lines belonging to an odd-number group and signal lines belonging to an even-number group.

Signal line drive circuits 13B1, 13B2 have respective configurations identical to each other. In the following, the configuration of signal line drive circuit 13B1 will be described as a representative one.

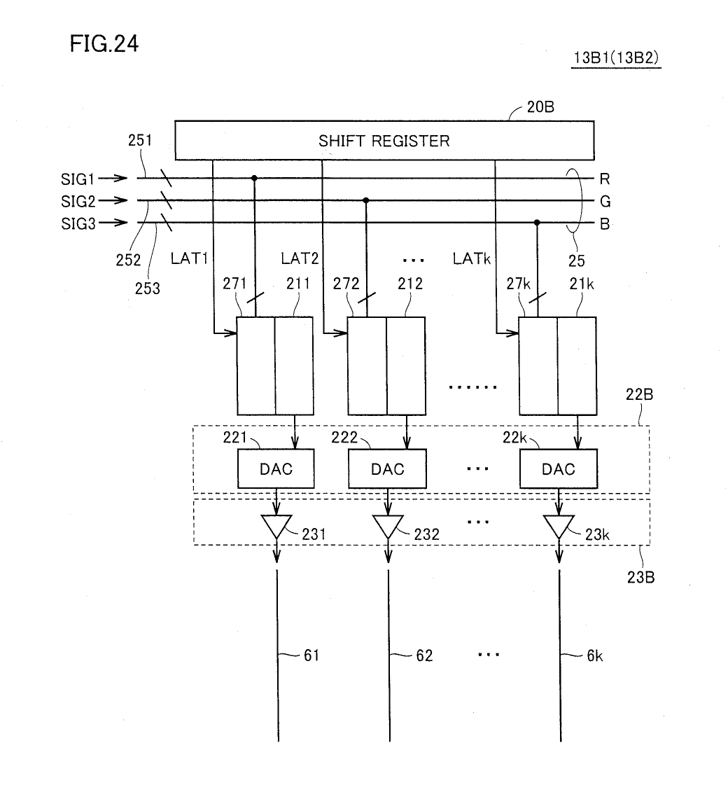

FIG. 24 is a diagram showing a configuration of signal line drive circuit 13B1 shown in FIG. 23. Referring to FIG. 24, signal line drive circuit 13B1 includes a shift register 20B, k (k=m/2) latch circuits 211 to 21k, and latch circuits 271 to 27k. Latch circuits 271 to 27k are arranged in respective preceding stages of latch circuits 211 to 21k. Like the second embodiment, two-stage latch circuits are provided for one column. The two-stage latch circuits constitute “latch circuit” of the present invention.

Signal line drive circuit 13B1 further includes a D/A conversion unit 22B and an output unit 23B. D/A conversion unit 22B includes D/A converters (DAC) 221 to 22k provided correspondingly to latch circuits 211 to 21k, respectively. Output unit 23 includes output buffers 231 to 23k provided correspondingly to D/A converters 221 to 22k, respectively. Output buffers 231 to 23k output analog signals to data signal lines 61 to 6k, respectively.

As shown in FIG. 24, in the third embodiment, one D/A converter and one output buffer are arranged for each data signal line. Namely, the drive method in the third embodiment is the complete line sequential drive method. Signal line drive circuits 13B1, 13B2 are arranged on substrate 1 and thus a plurality of latch circuits, conversion units, and output units are divided into two blocks.

Shift register 20B outputs signals LAT1 to LATk to latch circuits 271 to 27k, respectively. In response to signals LAT1 to LATk respectively, latch circuits 271 to 27k take in and latch pixel data signals from data bus 25. Then, latch circuits 271 to 27k output respective pixel data signals having been taken therein to the latch circuits of respective subsequent stages (latch circuits 211 to 21k respectively).

Latch circuits 211 to 21k each output the pixel data signal to the corresponding D/A converter. The pixel data signals that are output respectively from latch circuits 211 to 21k are each converted by the corresponding D/A converter into an analog signal. The analog signal from the D/A converter is output to corresponding data signal line 6 through the output buffer.

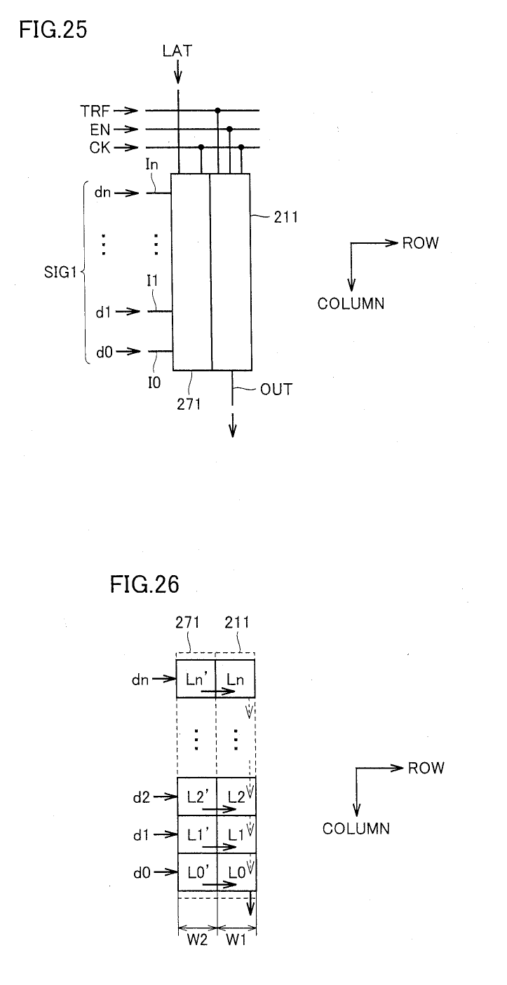

FIG. 25 is a diagram for illustrating input and output of latch circuits 211, 271 shown in FIG. 24. Referring to FIG. 25, latch circuit 271 receives signal LAT1, clock CK, and bit data d0 to dn constituting pixel data signal SIG1. Latch circuit 271 receives bit data d0 to dn at a time, and transfers these bit data at a time to latch circuit 211. Namely, latch circuit 271 is a parallel-input parallel-output type latch circuit.

Latch circuit 211 has two operation modes, and switches between the two operation modes alternately based on signal EN. In the first mode, latch circuit 211 receives a plurality of bit data at a time from latch circuit 271. In the second mode, latch circuit 211 sequentially outputs from output node OUT a plurality of bit data bit by bit in synchronization with clock CK. Latch circuit 211 and latch circuit 271 are arranged along the row direction.

FIG. 26 is a diagram schematically illustrating the configuration of latch circuits 211, 271 shown in FIG. 25. Referring to FIG. 26, latch circuit 211 includes a plurality of latch unit circuits L0 to Ln arranged in series in the column direction. Latch circuit 271 includes a plurality of latch unit circuits L0′ to Ln′ arranged in series in the column direction.

The length (width W1) in the row direction of each of latch unit circuits L0 to Ln and the length (width W2) in the row direction of each of latch unit circuits L0′ to Ln′ are each equal to or less than the pixel pitch. The number of latch unit circuits included in one latch circuit is equal to the number of bits of pixel data. Latch unit circuits L0 to Ln, L0′ to Ln′ each latch and transfer one-bit data.

Latch unit circuits L0 to Ln each have two input paths and one output path. One of the two input paths is a path into which corresponding bit data of a plurality of bit data (d0 to dn) constituting pixel data is input. The other of the two input paths is connected to the output path of the latch unit circuit in the preceding stage.

Latch unit circuits L0′ to Ln′ each have one input path. Latch unit circuits L0′ to Ln′ each latch the corresponding bit data of a plurality of bit data and transfer the bit data to the latch unit circuit (corresponding latch unit circuit of latch unit circuits L0 to Ln) arranged in its subsequent stage.

Latch unit circuits L0 to Ln each have a configuration similar to the configuration shown in FIG. 7 for example. In the third embodiment, signals TRF, EN correspond respectively to control signals G1, G2 shown in FIG. 7. Latch unit circuits L0′ to Ln′ each have a configuration similar to the configuration shown in FIG. 21. In the third embodiment, signals LAT1 to LATk each correspond to control signal G shown in FIG. 21.

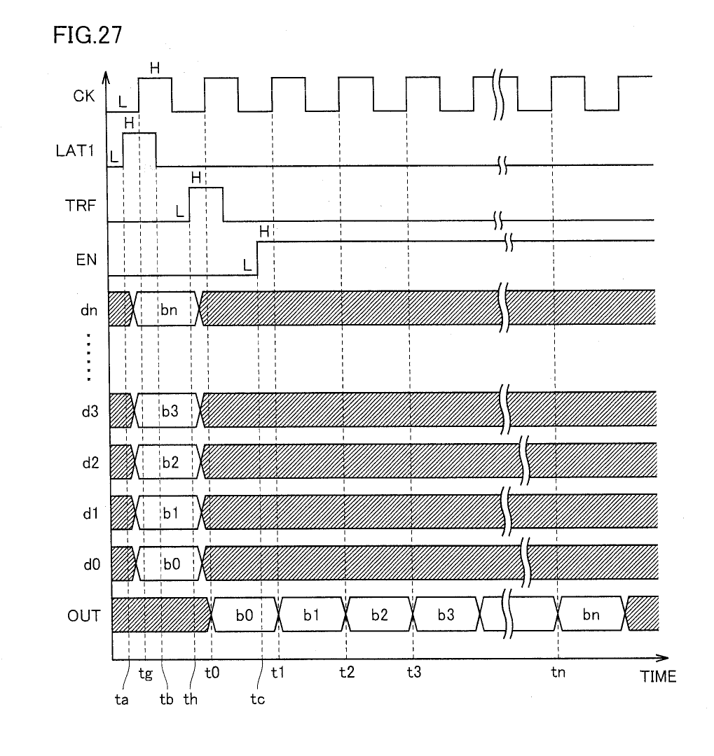

FIG. 27 is a timing chart showing operation waveforms of latch circuits 211, 271 made up of the latch unit circuits shown in FIGS. 25 and 26. Referring to FIG. 27, time ta, t0, tb, tc, t1, t2, t3, tn correspond respectively to time ta, t0, tb, tc, t1, t2, t3, tn shown in FIG. 8.

At time ta, the level of signal LAT1 changes from the L level to the H level. Accordingly, transistor Tr1 of latch unit circuits L0′ to Ln′ each is turned on.

At time tg, the level of clock CK changes from the L level to the H level. Accordingly, latch unit circuits L0′ to Ln′ latch bit data d0 to dn, respectively. Namely, latch circuit 271 obtains a plurality of bit data at a time.

At time tb, the level of signal LAT1 changes from the H level to the L level. Accordingly, transistor Tr1 in latch unit circuits L0 to Ln each is turned off. In contrast, at time th, the level of signal TRF changes from the L level to the H level. Accordingly, the operation mode of latch unit circuits L0 to Ln each is set to the first mode.

At time t0, clock CK rises. Latch unit circuits L0 to Ln obtain the bit data from latch unit circuits L0′ to Ln′, respectively. Bit b0 is taken by latch unit circuit L0 at time t0 and output from latch unit circuit L0 (from output node OUT of latch circuit 211).

At time tc, the level of signal EN changes from the L level to the H level. Accordingly, the operation mode of latch unit circuits L0 to Ln each switches from the first mode to the second mode. After time tc, each time clock CK rises, latch unit circuits L0 to Ln each transfer one-bit data. The operation of latch circuit 211 after time tl is similar to the operation of latch circuit 211 shown in FIG. 8.

Like the first and second embodiments, latch unit circuits L0 to Ln each may be a dynamic latch circuit having the configuration shown in FIG. 9. In this case, latch unit circuits L0′ to Ln′ each have a similar configuration to the configuration shown in FIG. 9, except that the number of input transistors is one.

According to the third embodiment, the signal line drive circuit is divided into the signal line drive circuits arranged separately on the upper side and the lower side of the display unit. Thus, latch blocks for one column, namely two-stage latch circuits, can be arranged in the row direction. The two-stage latch circuits are arranged in the row direction to thereby enable the width of the frame region, namely the length of the frame region along the column direction of the display unit to be reduced. Namely the frame region can be made narrower.

Further, the length in the row direction of the two-stage latch circuits each is equal to or less than the pixel pitch. Thus, the third embodiment can implement a liquid crystal panel into which a high-resolution display unit and a drive circuit are integrated, similarly to the first and second embodiments.

In the third embodiment, latch circuits 271 to 27k sample data in one horizontal period and transfer data to latch circuits 211 to 21k respectively in a retrace period. In the subsequent one horizontal period, D/A conversion unit 22B performs digital to analog conversion and output unit 23B outputs an analog signal to each data signal line. The third embodiment can extend the time taken for digital to analog conversion, similarly to the second embodiment. Thus, the third embodiment can implement high-quality display even if the display specification requires both the high definition and high operation drive frequency.

Further, the latch circuits (latch circuits 271 to 27k) in the first stage transfer, to the latch circuits (latch circuits 211 to 21k) in the second stage, a plurality of bit data in parallel. In this way, the time required for a process of transferring data from the latch circuits in the first stage to the latch circuits in the second stage can be shortened.

Furthermore, the third embodiment eliminates the need for the circuit (such as line selector) for the time-division process. Thus, the size of the signal line drive circuitry can be reduced.

[Electronic Apparatus]

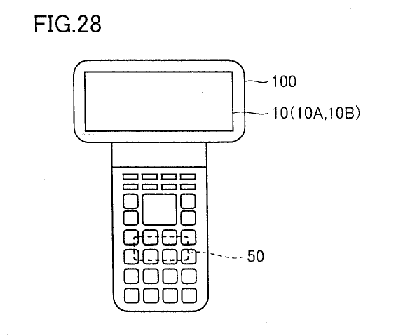

FIG. 28 is a diagram showing an example of an electronic apparatus including a display device according to an embodiment of the present invention. Referring to FIG. 28, a mobile phone 100 is an electronic apparatus including liquid crystal panel 10 in the first embodiment and a controller 50 for causing liquid crystal panel 10 to display an image. Instead of liquid crystal panel 10, liquid crystal panel 10A in the second embodiment or liquid crystal panel 10B in the third embodiment may be:mounted on mobile phone 100. In the present embodiment, a liquid crystal panel into which a high-resolution display unit and a drive circuit are integrated can be implemented. The present embodiment can thus implement an electronic apparatus including a high-resolution display unit.

The present invention is applicable to electronic apparatuses mounted with liquid crystal display devices. The electronic apparatus including the display device in the present embodiment is therefore not limited to mobile phones. For example, the liquid crystal display device in the present embodiment for example may be mounted on a smart phone, PDA (Personal Digital Assistant), PND (Portable Navigation Device), digital camera, mobile game equipment, personal computer, or the like.

Further, in connection with the above-described embodiments, a liquid crystal display device is illustrated by way of example as the display device according to the embodiments of the present invention. The present invention is applicable to display devices obtained by forming on a substrate a display unit as well as a circuit converting digital data into analog data for driving the display unit as one integral unit. In such a display device, the circuit size may be restricted by the pixel pitch, and therefore, the present invention is applicable to the display device. The present invention is therefore also applicable for example to an organic EL (Electro Luminescence) display device.

It should be construed that embodiments disclosed herein are by way of illustration in all respects, not by way of limitation. It is intended that the scope of the present invention is defined by claims, not by the above description above, and encompasses all modifications and variations equivalent in meaning and scope to the claims.

### REFERENCE SIGNS LIST

2 pixel display circuit; 4, 41, 42 scan line; 5 common potential line; 6, 61-6k data signal line; 7 liquid crystal cell; 7A, 7B electrode; 8 N-type transistor; 9 capacitor element; 10, 10A, 10B liquid crystal panel; 11 substrate; 12 display unit; 13, 13A, 13B1, 13B2 signal line drive circuit; 14 scan line drive circuit; 16 peripheral circuit; 17 signal terminal; 20, 20B shift register; 22, 22A, 22B D/A conversion unit; 23, 23A, 23B output unit; 25 data bus; 251-253 bus; 30 latch region; 50 controller; 100 mobile phone; 211-21m, 261-26m, 271-27k latch circuit; 221-22m, 321-321 D/A converter; 231-23m, 331-33/ output buffer; 241-24m level shift circuit; 251-253 bus; 321-32m D converter; 341-34m line selector; b0-bn bit; C1, C2, Ca, Cb capacitor; d0-dn bit data; GT1-GT3 gate circuit; IO-In input node; INV, INV1, INV2 inverter; L0-Ln, L0′-Ln′ latch unit circuit; LB1-LB/ latch block; MN1-MN5, MP1-MP3, Tr1-Tr3 transistor; N1, N2 input node; N3, OUT, OUTI, OUT2 output node; N4 node; Ng ground node; S1-S4 switch

1. A drive device for a display circuit,
said display circuit including a plurality of pixel display circuits arranged in a plurality of rows and a plurality of columns, and a plurality of signal lines provided for said columns respectively and extending along a direction of said columns, said drive device comprising:
a plurality of latch circuits provided correspondingly to said plurality of signal lines respectively and each configured to obtain a plurality of bit data at a time that constitute pixel data and output said plurality of bit data sequentially,
said plurality of latch circuits each including a plurality of first latch unit circuits arranged in series along said direction of the columns and each configured to obtain one-bit data and transfer said one-bit data;
a conversion unit configured to convert into an analog signal said plurality of bit data that are output from each of said plurality of latch circuits; and
an output unit configured to output said analog signal from said conversion unit to a corresponding signal line of said plurality of signal lines.

2. The drive device for a display circuit according to claim 1, wherein
at least one latch unit circuit of said plurality of first latch unit circuits includes:
an output node for outputting said one-bit data to a stage subsequent to said at least one latch unit circuit;
a first input node for receiving corresponding bit data of said plurality of bit data; and
a second input node for receiving said one-bit data from a stage preceding said at least one latch unit circuit.

3. The drive device for a display circuit according to claim 2, wherein
said at least one latch unit circuit is configured so that one of a first mode and a second mode can be selected,
said at least one latch unit circuit in said first mode receives said corresponding bit data from said first input node in response to a control signal and outputs said one-bit data from said output node, and
said at least one latch unit circuit in said second mode receives said one-bit data from said second input node and outputs said one-bit data from said output node.

4. The drive device for a display circuit according to claim 3, wherein
said at least one latch unit circuit is configured to output said one-bit data in synchronization with a clock.

5. The drive device for a display circuit according to claim 3, wherein
said control signal is a single-phase signal.

6. The drive device for a display circuit according to claim 1, wherein
said plurality of latch circuits (211 21m) are arranged along a direction of said rows,
said conversion unit includes a plurality of conversion circuits provided correspondingly to said plurality of latch circuits respectively and configured to convert into said analog signal said plurality of bit data that are output from a corresponding latch circuit, and
said output unit includes a plurality of output buffers provided correspondingly to said plurality of conversion circuits respectively and configured to output said analog signal that is output from a corresponding conversion circuit to a corresponding signal line.

7. The drive device for a display circuit according to claim 1, wherein
said plurality of latch circuits are arranged along a direction of said rows,
said conversion unit includes a plurality of conversion circuits each provided for a predetermined number of latch circuits of said plurality of latch circuits and configured to convert into said analog signal said plurality of bit data that are output from each of said predetermined number of latch circuits, and
said output unit includes a plurality of selectors provided correspondingly to said plurality of conversion circuits respectively and configured to select, in a time-division manner in a predetermined period of time, one of said analog signals that are output from a corresponding conversion circuit and output the selected analog signal to a corresponding signal line.

8. The drive device for a display circuit according to claim 7, wherein
said plurality of latch circuits are arranged along the direction of said rows,
said plurality of latch circuits each further include a plurality of second latch unit circuits provided correspondingly to said plurality of first latch unit circuits respectively and arranged in series with corresponding first latch unit circuits along said direction of the columns, and said plurality of second latch unit circuits are each configured to sequentially transfer said plurality of bit data that are output from corresponding first latch circuits to a stage subsequent to said second latch unit circuit.

9. The drive device for a display circuit according to claim 1, wherein
said plurality of latch circuits, said conversion unit, and said output unit are divided into a first block and a second block that are arranged along said direction of the columns so that said display circuit is located between said first and second blocks,
said plurality of latch circuits each further include a plurality of second latch unit circuits provided respectively in respective preceding stages of said plurality of first latch unit circuits, and
said plurality of second latch unit circuits are each configured to latch corresponding bit data of said plurality of bit data and transfer said corresponding bit data to said first latch unit circuit arranged in a stage subsequent to said second latch unit circuit.

10. A display device comprising:
a display circuit including a plurality of pixel display circuits arranged in a plurality of rows and a plurality of columns, and a plurality of signal lines provided for said columns respectively and extending along a direction of said columns; and
a drive circuit for driving said display circuit,
said drive circuit including:
a plurality of latch circuits provided correspondingly to said plurality of signal lines respectively and each configured to obtain a plurality of bit data at a time that constitute pixel data and output said plurality of bit data sequentially,
said plurality of latch circuits each including a plurality of latch unit circuits arranged in series along said direction of the columns and each configured to obtain one-bit data and transfer said one-bit data;
a conversion unit configured to convert into an analog signal said plurality of bit data that are output from each of said plurality of latch circuits and
an output unit configured to output said analog signal from said conversion unit to a corresponding signal line of said plurality of signal lines.

11. The display device according to claim 10, wherein
said display circuit and said drive circuit are formed integrally on an insulating substrate.

12. The display device according to claim 10, wherein
said plurality of pixel display circuits each include a liquid crystal cell.

13. An electronic apparatus comprising:
a display device; and
a processor for causing said display device to display an image,
said display device including:
a display circuit including a plurality of pixel display circuits arranged in a plurality of rows and a plurality of columns, and a plurality of signal lines provided for said columns respectively and extending along a direction of said columns; and
a drive circuit for driving said display circuit,
said drive circuit including:
a plurality of latch circuits provided correspondingly to said plurality of signal lines respectively and each configured to obtain a plurality of bit data at a time that constitute pixel data and output said plurality of bit data sequentially,
said plurality of latch circuits each including a plurality of latch unit circuits arranged in series along said direction of the columns and each configured to obtain one-bit data and transfer said one-bit data;
a conversion unit configured to convert into an analog signal said plurality of bit data that are output from each of said plurality of latch circuits and
an output unit configured to output said analog signal from said conversion unit to a corresponding signal line of said plurality of signal lines.
